(19) United States
(12) Patent Application Publication
(10) Pub. No.: US 2002/0177910 A1
(43) Pub. Date: Nov. 28, 2002

(54) Performance measurement system for large computer network

(76) Inventors: John S. Quarterman, Austin, TX (US); Andy Scherrer, Ham Lake, MN (US); Donald J. Fussell, Austin, TX (US); John W. B. Pate, Scotland (GB); Paul Murphy, Scotland (GB); Martin McCarthy, Scotland (GB); Shaun Dawson, Dallas, TX (US); Peter Salus, Austin, TX (US)

Correspondence Address: DRINKER BIDDLE & REATH, ONE LOGAN SQUARE, 18TH AND CHERRY STREETS, PHILADELPHIA, PA, 19103-6996, US

(21) Appl. No.: 09/929,608

(22) Filed: Aug. 14, 2001

Related U.S. Application Data
(63) Continuation-in-part of application No. 09/834,333, filed on Apr. 13, 2001.
(63) Continuation-in-part of application No. 09/834,662, filed on Apr. 13, 2001.
(63) Continuation-in-part of application No. 09/834,315, filed on Apr. 13, 2001.
(60) Provisional application No. 60/198,783, filed on Apr. 20, 2000.
(60) Provisional application No. 60/198,608, filed on Apr. 19, 2000.
(60) Provisional application No. 60/198,610, filed on Apr. 19, 2000.
(60) Provisional application No. 60/225,376, filed on Aug. 14, 2000.
(60) Provisional application No. 60/225,068, filed on Aug. 14, 2000.
(60) Provisional application No. 60/224,998, filed on Aug. 14, 2000.
(60) Provisional application No. 60/224,997, filed on Aug. 14, 2000.
(60) Provisional application No. 60/225,050, filed on Aug. 14, 2000.
(60) Provisional application No. 60/225,051, filed on Aug. 14, 2000.
(60) Provisional application No. 60/225,374, filed on Aug. 14, 2000.
(60) Provisional application No. 60/225,049, filed on Aug. 14, 2000.
(60) Provisional application No. 60/225,107, filed on Aug. 14, 2000.
(60) Provisional application No. 60/225,067, filed on Aug. 14, 2000.
(60) Provisional application No. 60/225,052, filed on Aug. 14, 2000.
(60) Provisional application No. 60/225,378, filed on Aug. 14, 2000.
(60) Provisional application No. 60/225,375, filed on Aug. 14, 2000.
(60) Provisional application No. 60/225,106, filed on Aug. 14, 2000.
(60) Provisional application No. 60/225,380, filed on Aug. 14, 2000.

(51) Int. Cl. G05B 13/02

(52) U.S. Cl. 700/28

(57) ABSTRACT

A method for measuring the performance of a large computer network is defined. The method provides a method of defining and characterizing the population of interest and interesting sub-populations; a method of providing a sampling list of nodes that represent the population; measuring the performance of destinations in the sampling list; recording raw data therefrom; reducing the raw data and providing presentations of information indicative of one or more of the sub-populations in ways that address questions of interest.

### CROSS-REFERENCE TO RELATED APPLICATIONS

This application is a continuation-in-part of application Ser. No. 09/834,333, which was filed Apr. 13, 2001 and claims the priority of application Ser. No. 60/198,783, filed Apr. 20, 2000; application Ser. No. 09/834,662, which was filed Apr. 13, 2001 and claims the priority of application Ser. No. 60/198,608, filed Apr. 19,2000; and application Ser. No. 09/834,315, which was filed Apr. 13, 2001 and claims the priority of application Ser. No. 60/198,610, filed Apr. 19, 2000, all of which nonprovisional applications are hereby incorporated by reference in their entireties. This application also incorporates by reference and claims the priority of application Ser. No. 60/225,376, which was filed on Aug. 14, 2000, application Ser. No. 60/225,068, which was filed on Aug. 14, 2000, application Ser. No. 60/224,998, which was filed on Aug. 14, 2000, application Ser. No. 60/224,997, which was filed on Aug. 14, 2000, application Ser. No. 60/225,050, which was filed on Aug. 14, 2000, application Ser. No. 60/225,051, which was filed on Aug. 14, 2000, application Ser. No. 60/225,374, which was filed on Aug. 14, 2000, application Ser. No. 60/225,049, which was filed on Aug. 14, 2000, application Ser. No. 60/225,107, which was filed on Aug. 14, 2000, application Ser. No. 60/225,067, which was filed on Aug. 14, 2000, application Ser. No. 60/225,052, which was filed on Aug. 14, 2000, application Ser. No. 60/225,378, which was filed on Aug. 14, 2000, application Ser. No. 60/225,375, which was filed on Aug. 14, 2000, application Ser. No. 60/225,106, which was filed on Aug. 14, 2000 and application Ser. No. 60/225,380, which was filed on Aug. 14, 2000.

### FIELD OF THE INVENTION

The invention relates to the field of computer networking. More specifically, the invention relates to a method of measuring the performance of a large computer network.

### BACKGROUND OF THE INVENTION

Computer networks are known to exhibit delays, the causes for which may be difficult to identify. This is especially true of the largest of computer networks, the Internet, which is considered a network herein, although it is really a network of networks. A typical Internet user wants to get information from a web server and not worry about anything that happens inside the Internet in between the server and the user's computer. However, an understanding of what happens within the Internet is important in characterizing its performance and detecting adverse events related thereto.

Internet Service Providers, referred to hereinafter as ISPs, are central to the transmission of all types of Internet data. The user connects to an ISP, which connects to other ISPs, one of which connects to the server the user is trying to reach. ISPs have complicated internal structure and interconnections (exchange points) between each other. Internet performance problems can arise in any part of the Internet: the user's connection, the user's ISP, the server's ISP, some other ISP, an exchange point (IX), or in other Internet infrastructure such as nameservers. All ISPs are different, and many are not appropriately comparable with one another.

To characterize performance or detect a significant event within the Internet cloud, precision is needed, which means that data must be collected about a very large number of nodes, computers connected to the Internet. As of September 2001 there are estimated to be about 150,000,000 Internet nodes. This is the largest population of interest.

In order to accurately characterize the performance of such a large network, there is a need for a system for classifying nodes and groups of nodes in an organized way. Massive amounts of data regarding topology, use, and ownership of nodes must be gathered. Thus, there is a need for gathering this type of data in the required amounts in a reasonable time, which can not be filled by known techniques.

Further, there exists a need for methods of creating lists of sample nodes large enough to be representative of the entire Internet and for collecting vast amounts of data with a broad view of the entire network. Still further, a need exists for methods of reducing such vast amounts of data to manageable information and methods of presenting information indicative of network performance in a useful way. In addition, all of this must be done in a relatively short time, so that users can see the results of these methods before they are obsolete.

Thus, a need exists for a general method of measuring Internet performance, for comparing individual ISPs, and for detecting and informing users of Internet performance events.

### SUMMARY OF THE INVENTION

The present invention relates to a method for measuring the performance of large computer networks. Among other capabilities, variations of the method are capable of characterizing the overall performance of a large network, comparing the performance of individual ISPs in the Internet, detecting events (usually adverse) occurring in a large network, and displaying useful information derived from performance data to a user.

The invention involves a number of steps. First, a general list of network nodes is provided. The list may be obtained from various sources, may be created using novel methods described herein, or may be hybridized from these or other sources. A sampling list, which is representative of at least a portion of the nodes is created. The sampling list is derived from the general list through methods described herein, or is obtained from an outside source. Once created, the sampling list may be maintained using additional methods, also described herein. The measurement of network performance involves sending signals to a relatively large number of destinations in a relatively short time, which is preferably done by running an algorithm on at least a part of the sampling list simultaneously.

More specifically, the preferred algorithm calls for signals to be sent from a beacon to a plurality of nodes on the sampling list. The signals request responses from the plurality of nodes. Simultaneously, the beacon receives return signals from responding nodes, such that the signal being received at any particular time could correspond with any of the signals sent to one of the plurality of nodes.

Data characterizing the corresponding sent and received signals is recorded as the process progresses. The raw results of data collection must be reduced to a useable form and any number of mathematical operations may be performed to create statistics indicative of the performance of at least a portion of the network. The statistics are displayed to a user such that the user is able to draw conclusions about the performance of the network.

### BRIEF DESCRIPTION OF THE DRAWINGS

FIG. 1 is a flowchart showing a method of collecting, processing, and displaying information indicative of the performance of at least a portion of a computer network according to the present invention.

FIG. 2 is a flowchart depicting a preferred embodiment of mtraceroute, a method of gathering information relating to network topology, according to the present invention.

FIG. 3 is a flowchart depicting a preferred embodiment of mping, a method of collecting data, according to the present invention.

FIG. 4 is a schematic of a sliding average method for detecting performance events according to the current invention.

FIG. 5 is a schematic of a filter method for detecting performance events according to the current invention.

FIG. 6 is a schematic of an evaluation method for detecting performance events according to the current invention.

FIG. 7 depicts a preferred ratings table according to the present invention.

### DETAILED DESCRIPTION OF THE DRAWINGS

As noted above, the invention is capable of measuring the performance of a computer network or a portion of a network. The invention is particularly effective when used in connection with large networks. The invention is specifically tailored for measuring the very largest of computer networks, the Internet. Thus, the preferred embodiments of the invention shall be at times described with regard to its application to the Internet, but is not so limited.

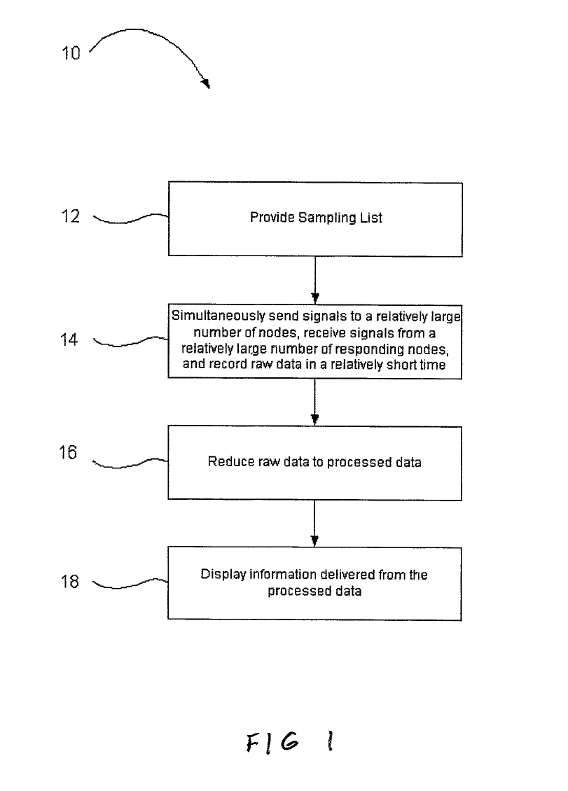

Referring to FIG. 1, a method 10 for collecting, processing and displaying information indicative of the performance of at least a portion of a computer network is shown. The first step 12 of the procedure is to provide a sampling list. It is contemplated that sampling lists may be obtained commercially, but are preferably created for a particular purpose using novel methods disclosed herein. The sampling list comprises information indicative of representative nodes on the network, such as IP address or domain name address, or a URL. The second step 14 is data collection, which is performed by sending signals to a relatively large number of nodes in a relatively short time. While signals are continually being sent, signals are simultaneously received from responding nodes. It should be made clear that the sending and receiving procedures are complementary and are performed substantially continuously and simultaneously over a certain time interval. For example, if 10,000 signals are sequentially sent over a 15 minute time interval, a response to the first signal may be received before the tenth signal is sent. Of those 10,000 signals, some smaller number, such as 300, may be flying, that is pings may have been sent for them and responses may not have been received yet, and a response for any one of those 300 signals may be received at any time in any order. The time that corresponding signals are sent and received is recorded as raw data as the complementary procedures continue. In this way, relatively large amounts of performance data is obtained in a relatively short period of time. The next step, box 16, is to reduce the raw data to processed data. This is necessary due to the vast amounts of data collected by the methods described herein. Information derived from the processed data is then displayed, box 18, to a user in a format which allows a user to quickly see an indication of the performance of at least a portion of the network.

In order to collect data that is truly representation of a network, or some portion of the network in which there is interest, a sampling list that represents the network or the interesting portion must be created. However, before this can be done effectively, the proper population of interest must be defined.

### Defining the Target Population

The first step in analyzing any large network according to the preferred embodiments of the invention is defining the target population; that is, the set of nodes and networks in which there is interest. The Internet is both immense and extremely complex. While technically, it consists of nodes connected by links for the purpose of data transmission, the Internet hosts a myriad of activities. Therefore, people are often concerned with some part of the whole. The careful definition of the population of interest is critical in the proper interpretation of any data that is collected. While any part of the Internet is likely to have its own unique characteristics, there are ways to determine useful criteria for categorizing different aspects of any sub-population.

In order to effectively address the right questions about a sub-population in the most appropriate manner attainable, a flexible classification approach that allows for in-depth study of any sub-population in a consistent manner is provided. It is noteworthy that the invention may be used to explore the attributes of any interesting group of nodes on the Internet. Frequently, the most interesting groups of nodes are ISPs, and for the purpose of clarity, the invention will now be described in terms relating to ISPs, but of course, is not so limited. The approach defines a profile for classifying a network that comprises two levels of grouping: first by ISP, then by service types.

ISP grouping will be described first. ISPs are central to the transmission of all types of Internet data. For this reason, performance is viewed by centering on its characteristics within and between ISPs. All ISPs are different, and many are not appropriately comparable with one another. Therefore, some classification is necessary before any comparisons are sensible. Criteria for classification are based on three major factors, size, distribution and emphasis.

There are many criteria for determining size. One criterion is a rough estimate of capacity to determine the largest ISPs. ISPs generally have a good idea of their size, and there is a rather strong consensus among ISPs as to which ISPs are the biggest. Small ISPs tend to be local to a city or metropolitan region or state, and thus also easy to distinguish. Mid-size ISPs are all the others. When a specific distinguishing factor is needed, numbers of supercore routers may be utilized, for example: big ISPs may be classified as having at least 6; mid-size ISPs as having at least 3; and small ISPs as having at least one. As the size of ISPs continues to grow in general, such classifications require appropriate updating. There are also many other ways of sizing ISPs, such as by numbers of Points of Presence (“PoPs”), numbers of users volume of traffic, etc. Many such measures of ISP size and related data can be estimated.

Example ISP size categorization scheme:

| ISP Size # | supercore # | routers # | Web # | other # | total |
|---|---|---|---|---|---|
| Lit | 1 | 4 | 6 | 10 | 20 |
| Mid | 3 | 100 | 18 | 25 | 55 |
| Big | 6 | 500 | 55 | 100 | 180 |

(Lit, Mid and Big are the terms used for little, mid-sized, and big.)

Distribution can be expressed in terms of local, national, or world geography, depending somewhat on size. Once again, ISPs tend to know into which category they fit. Worldwide ISPs especially insist on being classified as such.

Emphasis is a quantification in relation to any important aspects of an ISP that are not covered by some measure of size or regional distribution. Examples might be those ISPs which only support corporate customers, or which do co-location and do not provide general dialup services.

After grouping by ISP, the different functional roles or services provided by any group of nodes on the Internet is explored. Examples of roles which can be compared across ISPs include mail servers, DNS servers, routers, supercore, core, leaf dialup, web servers, game servers, chat servers, ftp-only sites, news services, search engines, and other popular services.

### Creating Sampling Lists

The next step is sampling, which involves choosing a set of Destinations that represent the Population. There are two levels on which sampling is defined: (1) how the ISP is characterized, (Size, Distribution), and (2) how a sampling list, also called a viewlist, of destinations within the ISP are selected to be representative of the Population. Size and Distribution are factors in determining the total number of destinations included in the viewlist, and where the destinations come from geographically. The second level reflects the emphasis. It is a relative weighting, relating to the determination of how many nodes represent each of the service categories.

Viewlists are used to group the destinations to be measured for any particular interesting group of nodes, often an ISP. Thus, viewlists are utilized to determine the destinations to which probes are sent. Viewlists are then used for organizing the summarization and presentation of the data once it has been collected. First, the procedure by which a viewlist may be created will be explained. Then, the processes of fine tuning and maintaining a viewlist will be described.

A population survey that lists almost all of the nodes on the Internet is an excellent tool with which to start. However, topological information is also beneficial, in addition to a simple list. To obtain such information, a list of main domains, such as utexas.edu, matrix.net, amazon.com, is extracted from the survey. For each of these main domains an example node is recorded, which are later used as destinations in traceroutes. Traceroutes may be performed from half a dozen beacons. For 100 million total Internet nodes, that's about 2 million traceroute destinations, or about 12 million traceroutes. Mtraceroute is a method of collecting these traceoutes and is described more particularly below. From this mass of traceroute data, topology information about ISPs is extracted.

Many different measures related to ISP Size can be deduced. Periodically one node per every organizational domain (such as utexas.edu, ibm.com, ucl.ac.uk) is tracerouted on the Internet worldwide. Tracerouting is a method of identifying the hops in between a source and a destination. One aspect of the present invention is mtraceroute, a novel method of collecting massive amounts of information regarding the paths by which data travels through the Internet. Although mtraceroute is but a single part of the overall system, it will be described in detail because it is very useful in quickly gathering large amounts of data from which viewlists may be produced.

### Mtraceroute

Mtraceroute will now be described with greater detail. Mtraceroute relates to a novel method of performing traceroutes, but may also be used as a secondary method of collecting data indicative of network performance. A traceroute operation involves querying the Internet as to the “path” that messages take when going from one computer to another. In other words, traceroute asks for the list of computers, known as hops, that a message is routed through on its way to the final destination for that message. Mtraceroute is preferably implemented in C and therefore may run on multiple computer operating systems.

The mtraceroute program accepts a list of Internet addresses and operational options and stores a data log of the performance and reachability measurements taken while executing each of those traceroutes. For each destination site specified in the list, mtraceroute gathers data on hops through which a message is routed when sent toward the destination. The data gathered for each “hop” includes: the order of the hop (i.e. was it the 3rd or 4th waypoint, etc); the Internet address (i.e. IP address); the name of the computer (i.e. domain name) whether that “hop” responded (i.e. was reachable); and total time taken receiving each response from a hop.

It is preferable that the mtraceroute method performs name lookups (i.e. DNS lookup) in advance, thus causing the name information to be readily available in fast memory. It is also preferred that mtraceroute establishes a time limit for each DNS operation to complete. If it is not complete in time, it is abandoned and that hop is considered “unnamed” rather than waiting. This allows processing to continue and a cap on server response time to be established.

Mtraceroute uses “multi-threading” to perform, in parallel, more than one traceroute measurement at a time, in a similar fashion as mping, a novel method of collecting performance data described below. The program reads a batch (also known as a chunk) of specifications into fast memory up front, performs and measures the traceroutes specified in the chunk in parallel (holding on to the data in fast memory), and when the chunk is completed, writes out all of the measurements for the batch to the data log on (slow) disk. Chunks are repeatedly processed until the complete list is processed. The size of the chunk is limited by the amount of fast memory available. However, the size of the batch is more usually set to permit enough simultaneous flying pings without overloading the local CPU or the network interface. Advantages and details of the chunking method are described under “Data Collection” with regard to mping, in which the underlying method was originally tested. The preferred embodiments of mtraceroute share those advantages and also benefits from some additional ones.

Mtraceroute performs more than one ping per hop and averages the results to get a more representative picture of performance and reachability for each hop.

Mtraceroute does not use UDP like some conventional data collection methods, instead sending ICMP ECHO requests (pings). Pings do not set off the same kind of alarms as UDP traceroute does. Thus, fewer complaints are received. The ICMP ECHO requests are sent in such a way as to transfer sufficient identification to ICMP error and ECHO responses so that mtraceroute can match them up to their corresponding ICMP ECHO requests.

Chunking allows mtraceroute to read in a chunk of destinations, such that a larger set of potential pings are available in slow memory than are permitted to be flying at a given time. Thus when a ping is finished, another ping can start immediately, keeping the number of pings flying high. This novel concept is described in more detail with regard to mping. A substantial difference between mtraceroute and mping, is that mtraceroute measures responses from each hop along the way to a destination, while mping is more interested in responses from the destination. Once a preselected maximum number of destinations are running at a particular time, mtraceroute completes an entire traceroute for one of the running destinations before permitting another destination to start running. Mtraceroute sends a ping toward each destination in a group of destinations to be pinged simultaneously for each hop, up to a predetermined number of hops. For example, pings may be set to expire, via a time to live parameter (“TTL”), at each of hops 1 through 15 for each of three destinations at the same time.

In mtraceroute, the number of hops to be pinged simultaneously for each destination is a runtime-settable option, which is by default half the total number of permitted hops. The default may be changed depending on the number of hops for each of the destinations under analysis, as seen by the measuring beacons. That default permits the traceroutes to most destinations to be completed without requiring a second pass (the second pass comprising pings set to TTLs of 16 through 30 where the pass included pings set to TTLs of 1 through 15), while minimizing the number of superfluous pings to hops after the final hops for that traceroute. Empirical evidence demonstrates that a typical traceroute takes about 7 hops and few traceroutes take more than 14 hops, thus 15 is an adequate default for the number of hops to be explored in the first pass.

If a successful hop is not encountered for a destination in the first pass, mtraceroute pings the next set of hops for that destination, and so on until a predefined number of maximum hops or a successful hop is reached. As long as there remain traceroute specifications left in the input list, the next specification is read, the corresponding traceroute is performed while timing its performance and, the measurements are written to the data log.

A preferred embodiment of mtraceroute may thus be summarized by the following steps: providing a list of traceroute specifications (a viewlist) and a set of global defaults; parsing the specification into its constituent parts; setting up a transaction request message; creating a TCP/IP socket and setting up input/output access to it; and for each potential “hop” up to the maximum allowed, sending a “ping” to the destination with the maximum allowed hops for that “ping” and setting the TTL to one more than the ping to the previous potential hop (where the numbering started at one); noting the timestamp for that ping transmission; waiting for a reply from the ping; noting the timestamp for that reply when it arrives and then calculate the time taken from transmit to reply; closing the socket and server connection.

There are four nested levels of queues. The input file comprising a list of destinations must be provided. A chunk comprises the list of destinations that will be processed without reading or writing to slow memory, the chunk usually being a subset of the input file. Running destinations are those destinations in the chunk which are actively having pings sent toward and received from, i.e. destinations drawn from the remaining uncompleted destinations in the chunk. Flying pings are pings in flight toward a running destination at any particular time and are drawn from the running destinations.

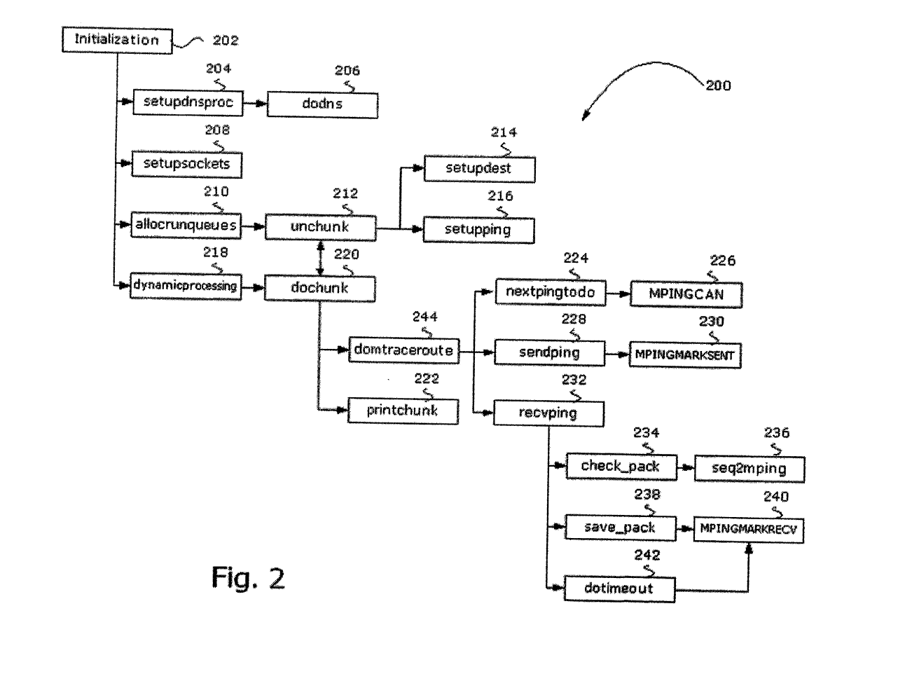

FIG. 2 represents a preferred implementation of mtraceroute. The initialization step 202 calls for a setupdnsproc routine 204, which checks for a user provided parameter to determine if domain name lookup is required and calls for a dodns subroutine 206 to perform the DNS look up if appropriate. Initialization 202 then calls for setupsockets 208, which establishes a socket for all outgoing network communication and a socket for incoming communication. A routine allocrunqueue 210 sets the chunk size in terms of destinations and in terms of pings to be sent, and calls for an unchunk 212 subroutine, which clears the memory associated with the last chunk processed. Unchunk 212 further calls for a setupdest routine 214, which establishes destination structures for each destination in the chunk and associated structures for each targeted hop. Unchunk 212 further calls setupping 216 which sets up data structures for each targeted hop, the set up involving allocating a pair of structures for recording time information for each sequential ping to be sent and response to be received per hop.

A main loop dynamicprocessing 218 is then called. The loop reads in a chunk of destinations, processes the chunk then writes the results back to slow memory. A subroutine, dochunk 220, is called to copy the number of destinations representing a chunk into fast memory from the input file, the number of destinations in the chunk being a number of destinations that can be processed through an algorithm without reading from or writing to slow memory. The processing of each destination involves sending pings toward each destination, the pings having TTL parameters corresponding with the hops through which the ping will travel. Dochunk 220 calls for domtraceroute 222, which sends and receives pings. Currently, it is contemplated that sending three pings with the same TTL toward each destination for each of up to a maximum number of hops provides appropriate data.

A sending procedure, which more or less continuously looks for “pingable destinations” until the entire chunk is processed, comprises the following steps. Subroutine nextpingtodo 224 pushes a destination structure onto a runstack, a term used to described a stack for holding destinations to be pinged. (Each mtraceroute process need utilize only one runstack.) The subroutine checks the runstack, and continues to copy destinations thereto as long as there are no “pingable” destinations therein. A pingable destination is one which has been pinged less than the preselected number of times. Another subroutine, mpingcan 226 checks the runstack for pingable destinations. If a pingable destination is found, a sendping 228 subroutine sends pings having appropriately set TTLs toward the destination, the pings each being encoded with identifying information, which information may be a sequence counter and a process identification. In addition, a subroutine mpingmarksent 230 increments a flying counter, and pushes the hop structure to a flystack, a term for a stack used to hold destinations which have pings flying. (Each mtraceroute process need utilize only one flystack.) Thus, the procedure of copying the hop structure to the flystack identifies the destination as having a ping in flight. The flying counter is simply a variable that tracks the number of pings in flight at any particular time.

A receiving procedure, recvping 232, may also be described as running generally continuously. As packets are received, the time of receipt is recorded and the packets are checked by subroutine check_pack 234 to determine if the packet receipt notes an error, if the packet is short, and whether the packet identification does not correspond with the mping process. If none of the conditions is true, a subroutine seq2mping 236 checks the destinations in the flystack for the corresponding structure, appropriately using the encoded identifying information. Assuming a corresponding structure is found, a save_pack subroutine 238 copies the time of receipt to the structure and calls for a subroutine mpingmarkrecv 240. Mpingmarkrecv 240 decrements the flying counter and pushes the structure back to the runstack if it has not been pinged the predetermined number of times. In addition, recvping 232, calls for a dotimeout subroutine 242, which checks the structure that has been in the flystack longest. If the oldest structure in the flystack has been in the flystack for longer than a preset maximum ping wait time, the packet in flight for that structure is considered lost and mpingmarkrecv 240 decrements the flying counter and pushes the destination back to the runstack if it has not been pinged the predetermined number of times.

Thus, as the receiving procedure is performed, information relating to the corresponding sent and received pings is recorded in fast memory. The recorded information includes indicators of the identity and address of the responding hop, and when the pings were sent and received. The structure is complete, for the purpose of current processing, when pings with the same TTL have been sent and marked received the predetermined number of times. The recorded information within the structure may be considered raw data. Once the chunk processing is complete, the raw data in the destination structures is written to slow memory by a printchunk routine 244.

### Use of Traceroute Data in Creating Viewlists

As noted above, viewlists list destinations that are to be measured. Thus, viewlists reflect the sampling design underlying the entire data collection methods. The representativeness of a viewlist is derived from the attributes that characterize the ISP. Each viewlist is designed to reflect with accuracy the size and emphasis of the ISP that is being measured with that viewlist; in terms of services that ISP provides, its geographical distribution, and the type of customers it serves. Initial viewlists can be created from a set of traceroutes. Vast quantities of traceroute data and lists of hostnames organized by top-level domain may be obtained using the method described above.

The data collected by tracerouting is used to determine Internet and individual ISP topology, link capacity, customers, etc. For example, it is straightforward to tell what domains belong to customers of a given ISP, simply by noting which ISP owns the last hop before the customer domain. The measures which can be deduced include: number of internal links; number of external links; number of routers; number of supercore routers; number of PoPs (points of presence); geographical location of each node; number of customer domains; capacities of links; number of cities connected; and number of countries connected. While approximate, these numbers provide information that aids in construction of initial viewlists. The data also helps determine which ISPs should be comparable. Further, these derivative measures are often of interest in themselves.

The relevance of data collected about particular types of Internet nodes must be examined before including them in a viewlist. Most of the nodes on the Internet are not important to the performance of other nodes on the Internet. One person's desktop workstation does not normally affect the performance of another person's workstation elsewhere in the Internet. Such workstations can generally be omitted, as well as routers in people's houses, and intranets behind firewalls.

Thus, the nodes of interest can be reduced to: (1) nodes that transfer traffic, such as Internet Service Provider (ISP) routers, ISP PoPs, and exchange points between ISPs; (2) servers that provide information users want to use, such as mail servers, FTP servers, and web servers; and (3) nodes that support the first two kinds of nodes, such as nameservers.

That reduces the population of interest to about 1,000,000 nodes, which is called comprehensive coverage. This number increases each year as the Internet grows.

Knowing roughly which nodes should be measured, it can be determined which nodes will become destinations for measurement using pings or other probes. Among the nodes included in comprehensive coverage, some are more important than others, because they carry more traffic. For example, there are currently about a dozen so-called Tier 1 ISPs which exchange traffic worldwide among themselves without charging each other for it. These Tier 1 ISPs carry a huge proportion of Internet traffic, which means that any performance problems on them will affect large numbers of Internet users and therefore large numbers of Internet servers and the companies that provide them. The Tier 1 ISPs are thus very interesting to measure. These ISPs along with some big exchange points and some important or popular servers compose the most immediate population of interest, which is called core coverage.

Having determined the immediate population of interest, there are still many steps involved in actually producing viewlists. An ISP population for each ISP of interest is collected. Properties of an ISP, such as domain names and network numbers, are used to extract nodes for that ISP from both the total Internet population survey and from the traceroute data. For each ISP, a list that includes almost all of the nodes inside that ISP is created, allowing for precise isolation of problems within the ISP. Then by trimming, testing, and tweaking the ISP populations, viewlists are constructed.

Trimming is used to exclude nodes of lesser interest, because there is little benefit in measuring every IP address used by a dialup ISP, nor ISDN links, nor DSL, nor every virtual web host. Test pinging removes immediately unreachable nodes. Categorization classifies the nodes for each ISP according to half a dozen service categories so as to compose balanced viewlists per ISP and to have comparable categories across ISPs. Correlation of destinations with those of any previous viewlist for the same ISP is performed. Localization determines the geographical location of every destination in the viewlist. Test deployment treats the viewlist as if in operation, but only for internal observation. Performance results observed for the test viewlist is compared against any previous viewlist for that ISP. Weeding subjects the viewlist to automated removal of dead destinations. It is preferred that as many, or optimally all of these steps be performed to the viewlist before putting the new viewlist into production, i.e. before data is collected.

Certain rules for trimming of viewlists are preferably followed. Viewlists should not contain: (1) destinations on/through an ISDN line or similar transitory or expensive link (unless specifically requested by a system user); (2) workstations or the like (i.e. machines which, for whatever reason, will be periodically switched off in the normal course of operation); (3) duplication, such as duplicate entries representing the same machine or multiple interfaces on the same machine (excepting when monitoring both sides of IX connections to ISPs.); (4) multiple machines inside a high performance network/LAN viewed through a single (or small set of) gateway machines, except in certain circumstances, such as a web email provider with forty customer facing servers on a single high performance internal network, because a user would likely not want to hit all of those machines, since the number which are available at any particular time affects service quality; and (5) machines requested not to be pinged by their owners.

Also prior to installing viewlists, it is preferred that they be checked for RFC1918 private addresses. These addresses may be used on enterprise networks, but must not be used on or publicized to the Internet. RFC 1918 addresses are the following address blocks:

10/8 (10.0.0.0->10.255.255.255)

172.16/12 (172.16.0.0->172.31.255.255)

192.168/16 (192.168.0.0->192.168.255.255)

If any RFC1918 addresses are present, the corresponding hostnames should be removed from the list. Certain other networks and nodes are also removed from viewlists before data collection.

If not already apparent, it will become clear that in addition to driving the mechanics of data collection, viewlists also are the statistical sample. Statistical validity of method results described hereinafter is related to the methods of building viewlists. Thus, it is preferred that viewlists are created by methods substantially like that described herein, and not created by randomly choosing a subset of all the ISP's nodes. Rather, sampling may be performed randomly within the groupings according to distribution and service type categories. This requires an understanding of the structure of the ISP's network. It also ensures that the sample is representative of the population.

The categorization criteria described above, provide the basis for a profile that captures all the important attributes of the network defined. Viewlists are formed by selection of nodes that fit the ISP/Service type profile (described above), with careful attention to which categories are represented and in what proportions. The different categories of destinations are also determined from traceroute data, via several indicators.

Routers are important destinations for measuring network performance. Research performed by Matrix.Net has found that data derived from router responses is quite valuable. Supercore routers tend to show quite stable response until a major performance event intervenes, and then the delay in ping response is more likely to be in intervening nodes than in the supercore routers themselves. Supercore routers show many traversals, and they are closely meshed with other supercore routers in their ISP, while they have no direct connections outside of the ISP. Core routers are regional or organizational routers between PoP and supercore routers. Ordinary routers are routers that are not otherwise distinguished. They are sometimes called transit routers and are in between other routers. These types of routers tend to show the most variation in latency. Some ISPs have transit routers that are only visible from paths that traverse certain pairs of PoP and supercore routers. Ordinary routers vary the most quickly in ping response with load of any of the types of destinations which have been measured. That response, in itself, quickly reveals when an ISP is loaded. DNS and news servers tend to vary the least in ping response with ISP load. Dialup and core routers show intermediate response. Comparisons of ping results among these types of destinations is much more informative than pinging only types of destinations that show the least reaction to load. In addition, pinging large numbers of destinations of all types greatly facilitates isolating performance problems to specific parts of the ISP and characterizing the type of performance event.

PoPs occur at the edges of ISPs just before customer nodes. The basic clue is the number of links branching out from the PoP, combined with a change of domain name or IP network number, and also clues in the domain names such as “isdn” or “ppp” or the like.

A customer node is a non-ISP node found in a traceroute just outside an ISP. The customer node is thus deduced to be a customer of that ISP. Some complexity may exist with regard to virtual web servers, but methods of detecting such servers are available.

A Point of Presence (PoP) is a telephone industry term that has been adopted by ISPs. It indicates a cluster of ISP equipment in a certain geographical location that is used to connect customer nodes. A PoP usually contains at least one router, but may contain multiple routers, as well as DNS servers, web servers, etc.

Web servers are normally leaf nodes and usually have www in their names. In addition, they normally respond to HTTP on TCP port 80.

DNS servers may be located by using DNS itself. They also respond to DNS queries. Many ISPs supply two different kinds of DNS service, the first about the ISP itself, and the second for customer domains.

Mail exchange servers are detectable via DNS MX records and because they respond to SMTP queries on TCP port 25.

Initial viewlists may serve as mere approximations of a representative sample and some oversights or errors in the list may be acceptable for most purposes. It is preferred that the user encourage input from the ISPs on the makeup of the viewlists that represent them. To prevent bias and maintain comparability across ISPs, it is highly preferred that the viewlists actually used for data collection are nonetheless determined by the measuring company, not by the ISPs themselves.

The lists should be monitored carefully to make sure they continue to serve as a good representative of the entire Internet in general, and the user's customers in particular. To remain representative of a population, viewlists must track the changes in the network they represent, as nodes are added, removed, or converted to different purposes. Destinations are preferably removed when they have been inactive for a period of days. Viewlists are preferably checked for this on a regular basis, most preferably weekly. New destinations will be added as the ISP grows and change in the types of service they provide.

Thus, to maintain a viewlist, (1) nodes that are really dead are removed or weeded out, so as not to artificially inflate the “packet loss” estimates, (described below); and (2) a mechanism for adding new destinations to a viewlist is provided, either because the ISP grows, or because one node that was weeded is replaced in function by a different node. This should include a channel through which the ISP can provide notices about changes it makes in its network.

Weeding occurs while a viewlist is in use for data collection. Weeding primarily deals with unreachable destinations. Weeding should remove the unwanted destinations from viewlists as promptly as is practicable. However, weeding should not remove destinations that are simply down for maintenance. A note should, however, be made that the destination should be removed temporarily from processing.

It may be desirable to treat new viewlists differently from established ones. For example, more aggressive weeding is appropriate for new lists. Established viewlists are more appropriately weeded via less aggressive methods to recover from false positive(s) in the weeding procedure.

It is preferable that a user evaluate and use as appropriate any feedback received from whatever source. There are two primary routes which a user can use to add new nodes to viewlists. One is by direct contact with an ISP to which the viewlist relates, the other is indirect and relates to the gathering of new traceroute data.

Direct contact involves contacting the ISP to be added. When an ISP is added to the set of viewlists, the ISP should be informed that their network is being measured; requested to supply a viewlist that the ISP recommends for measuring itself, and only then provided with a list of nodes that are included in the viewlist being used to measure the ISP; requested to provide feedback about which nodes are in that list but should not be, and which nodes are not in that list but which should be; and provided with a user contact should they wish to make updates or request information in the future. Feedback from the ISP should then be used to update the viewlist. Nonetheless, it is highly preferred that the measuring company make all final decisions as to the contents of viewlists, in order to maintain comparability of those viewlists across ISPs, as well as independence and credibility.

When a new set of traceroute data is gathered, the same procedure that is followed for creating a new viewlist should be followed for all the existing viewlists. Any new nodes, found from the new traceroute data may be added to the viewlist for that ISP (the existing nodes may be retained).

The amount of data collected is determined by the number of destinations being measured and the frequency with which those destinations are sampled.

The size of a viewlist will be governed by the size of the ISP being measured, as well as the number of different service areas they represent. The size of viewlists therefore ranges from a few to many thousands of destinations. A large portion of these destinations will be routers, since this service is at the heart of network performance.

### Data Collection

The processes by which data is collected involve measuring the individual performance of a relatively large number of nodes in a relatively short time. A relatively large number of nodes is a quantity of nodes greater than the number of nodes measurable by conventional techniques in a comparable time period. Conventional pinging is one known technique and is commonly performed at a rate of one ping per second. Thus, the large number of nodes is an adequate quantity of nodes to be a useful representation of the performance of one or more populations of interest during a particular time interval. For comparison of Tier 1 ISPs, for example, the relatively large number of nodes should be at least 2,000, but is preferably more than 10,000 nodes, and is most preferably more than 100,000 when scanned over a 15 minute time period. Thus, the data collection method described herein is capable of measuring more than twice, and preferably ten times, most preferably 100 times, the number of nodes that a conventional method in the same time period.

To measure the performance of the populations of interest, a beaconlist is constructed from one or more viewlists. Use of a beaconlist is a convenience in running methods of data collection, but of course, viewlists can be used directly. Thus, a beaconlist may comprise a list of representative nodes of a single population of interest, but may include representative nodes of a plurality of populations for the purpose of later comparing them.

Once a beaconlist is constructed, it may be provided to one or more beacons for measuring network performance. A beacon is any computer connected to the network that is running a data collection program, which directs the sending and receiving of signals. It is preferred that a beacon be capable of processing a portion of the destinations on a beaconlist, called a chunk, using the data collection program, without the need of reading information or writing information to slow memory. The step of “chunking” the beaconlists into chunks of a predetermined size provides several advantages. A chunk is of a size that can be run through a data collection program without accessing slow memory. Thus, chunk-sized lists may be processed using fast memory exclusively. When used herein, the term slow memory means disk storage, as opposed to fast memory, which may be RAM, cashe or other rapidly accessible memory. In addition, the data collection programs should process each chunks such that no more than insignificant adverse effects on perceived performance are detected. That is to say that not enough signals are being sent or received by a beacon at any particular time to appreciably affect the perceived metrics. Otherwise, an overactive beacon could cause adequate traffic in the network, particularly proximal to itself, to make latency, for example, appear greater than it really is.

Mping is a primary data collection method, which is preferably used in connection with the present invention. Ancillary methods, such as mtraceroute, may also be used.

### Mping

The mping program is a massively parallelized program designed to collect latency, packet loss, and reachability data from very large numbers of Internet destinations in a short time. The most preferred embodiment of mping is described below. The program is preferably implemented in C and therefore may run on multiple computer operating systems.

To collect data, mping sends several pings to each destination. For each response packet, mping records the time difference (latency) between when the original packet was sent and when its corresponding response was received. Mping also notes which probes do not receive responses within a timeout limit. To collect the data quickly, mping sends probes to many destinations simultaneously, solving the problem of performing latency probes (pings) in sequence taking too long and substantial time being wasted waiting for responses from the remote servers.

Mping solves the problem of performance timings being negatively affected by the act of reading ping specs from, or writing measurements to, disk storage by reading in a chunk of specifications up front, performing and measuring those pings in parallel (holding on to the data in fast memory), and when the chunk is completed, writing out all of the measurements for the chunk to the data log in slow memory. Chunks are repeatedly processed until the complete chunk is processed. As noted above, the size of the chunk is limited by the amount of fast memory available and constraints related to capacity of the network proximal to the beacon. However, the size of the chunk and the manner in which the chunk is processed in practice is usually set to permit enough simultaneous flying pings without overloading the local CPU. Mping avoids the problems associated with network interface and processor capacity by controlling (i.e. limiting) the number of pings performed in parallel independently of the chunk size.

Mping also solves a problem of the computer operating system limiting the number of communication “sockets” that may be open simultaneously (to a number much less than the desired number of simultaneous pings) by multiplexing all outgoing network transmissions through a single “socket” and de-multiplexing the replies received through a second “socket” by matching each response to an identifier for the original ping.

Mping also solves the problem of pings failing to complete in a timely fashion when remote servers fail to reply by establishing a time limit for each ping to complete. If the ping is not complete in time, it is abandoned and marked as lost rather than waiting for the computer system to detect that a failure has occurred.

Mping also solves the problem of some remote servers appearing to be out of service when they are not and the variation in the time taken for the ping to complete by performing more than one ping per destination and averaging the results to get a more representative picture of performance and reachability.

Mping solves the problem of the program potentially getting confused due to messages other than the expected reply to the ping being received from the remote servers by filtering out all unwanted messages at the point of message receipt and only passing the expected messages on to the rest of the program.

Mping also solves the problem of running multiple pings simultaneously in a chunk not producing adequate speed of data collection. This is possible because the invention relates not only to chunking, but also a procedure whereby each chunk of destinations that is read in provides a larger set of potential pings than are permitted to be flying at a given time. Thus when a ping is finished (response received or maximum time exceeded), another ping can start immediately, thus keeping the number of pings flying high.

Mping solves the problem of looking up the name of a destination taking a long time and slowing down processing by precomputing the name lookups (i.e. DNS lookup) so that the actual mping data collection can work from IP addresses.

While there are more destinations left in a chunk, the next specification is read, that ping is performed while its performance is timed (described in more detail below), and, the measurements are written to a data log.

The logic of the measurement for a given destination and a set of global defaults is performed by the steps of: parsing the specification into its constituent parts; setting up the transaction request message; creating a TCP/IP socket and setting up input/output access to it; sending a “ping” to the destination; noting the timestamp for that ping transmission; waiting for a reply from the ping; noting the timestamp for that reply when it arrives; and calculating the time taken from transmit to reply. The socket and server connection can then be closed. However, normally mping sends and receives many pings and replies interspersed with one another.

There are three nested levels of queues. The first is input, as large as the input file. The input file is a beaconlist (or a viewlist). A chunk comprises the list of destinations that will be processed without reading or writing to slow memory, the chunk usually being a subset of the input file. The input queue is treated as an array, with a steadily increasing index. When a new destination to ping is needed from the input queue, the one indicated by the index is used, and the index is incremented. The second level, called runstack, comprises destinations which are immediately available for pinging. Pings in runstack are drawn from the input queue as needed. The third level, called flystack, comprises destinations which have pings currently flying. Pings in runstack are drawn from runstack as needed. When a ping is received for a destination, a link to the structure representing that destination is removed from flystack and put back on runstack, from whence it will later be moved back to flystack for further pinging, until that destination has been pinged the maximum number of times permitted. The input queue is treated as an array, with a steadily increasing index. When a new destination to ping is needed from the input queue, the one indicated by the index is used, and the index is incremented.

In general, ICMP (ping) packets are used to measure destinations of interest. This is advantageous because it provides a uniform packet type to apply across all protocols and service, and thus provides a means by which interpretation of the performance numbers, and comparisons across protocols can be performed.

The mping method utilizes a specially optimized form of the familiar “ping” (ICMP echo), mping being ideal for measuring the performance of very large numbers of simultaneous destinations. Mping provides information on various metrics, usually latency, packet loss, and reachability for the measured destinations.

Latency and packet loss information is obtained from the time between sending a ping and receiving a corresponding echo and the number of packets sent for which a response is received from the destination. Packets may be sent in groups. A group of pings sent to a single destination node is called a bong. Reachability information is obtained from the number of bongs which do not return a single echo to the source, such that a destination which returns no echo for a bong is considered unreachable.

The frequency with which those destinations are sampled is also important. It has been found that optimal measuring may be performed at 15 minute intervals. This interval allows for a high resolution summary of performance conditions through time, as well as rapid detection of problems or other events when they occur.

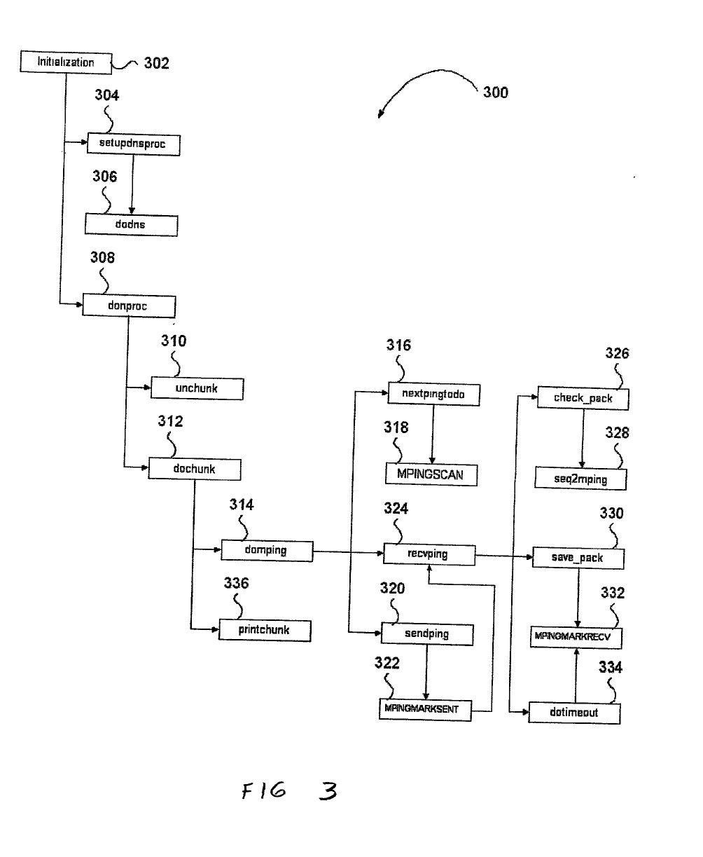

Referring now to FIG. 3, which represents the most preferred embodiment of mping currently contemplated, the initialization step 302 calls for a setupdnsproc routine 304, which establishes a socket for all network communication, and calls for a dodns subroutine 306 if a user supplied parameter calls for a DNS look up to be performed. The main loop, donproc 308, is then begun. First, an unchunk 310 subroutine clears the memory associated with the last chunk processed. Another subroutine, dochunk 312, copies the number of destinations representing a chunk into fast memory from a beaconlist, the number of destinations in the chunk being a number of destinations that can be processed through an algorithm without reading from or writing to slow memory. The processing of each destination involves pinging each destination a predetermined number of times and is run by domping 314. Currently, it is contemplated that pinging each destination six times is adequate to collect appropriately representative data.

A sending procedure, which more or less continuously looks for “pingable” destinations until the entire chunk is processed, comprises the following steps. Subroutine nextpingtodo 316 selects the next destination from the chunk and pushes it to a runstack, a term used to described the stack for holding destinations to be pinged. (Each mping process need utilize only one runstack.) A subroutine checks the runstack, and continues to copy destinations thereto as long as there are no “pingable” destinations therein. A pingable destination is one which has been pinged less than a preselected number of times. Another subroutine, mpingcan 318 checks the runstack for pingable destinations. If a pingable destination is found, a sendping 320 subroutine sends a ping to that destination encoded with identifying information, which information may be a sequence counter and a process identification. In addition, a subroutine mpingmarksent 322 increments a flying counter, and pushes the destination to a flystack, a term for a stack used to hold destinations which have pings flying. (Each mping process need utilize only one flystack.) Thus, the procedure of copying the destination to the flystack identifies the destination as having a ping in flight. The flying counter is simply a variable that tracks the number of pings in flight at any particular time.

A receiving procedure, recvping 324, may also be described as generally continuous. As packets are received, the time of receipt is recorded and the packets are checked by subroutine check_pack 326 to determine if the packet receipt notes an error, if the packet is short, and whether the packet identification does not correspond with the mping process. If none of the conditions are true, a subroutine seq2mping 328 checks the destinations in the flystack for the corresponding destination, appropriately using the encoded identifying information. Assuming a corresponding destination is found, a save_pack subroutine 330 copies the time of receipt to the destination and calls for a subroutine mpingmarkrecv 332. Mpingmarkrecv 332 decrements the flying counter and pushes the destination back to the runstack if it has not been pinged the predetermined number of times. In addition, recvping 324, calls dotimeout subroutine 334, which checks the destination that has been in the flystack longest. If the oldest destination in the flystack has been in the flystack for longer than a preset maximum ping wait time, the packet in flight for that destination is considered lost and mpingmarkrecv 332 decrements the flying counter and pushes the destination back to the runstack if it has not been pinged the predetermined number of times.

Thus, as the receiving procedure is performed, information relating to the corresponding sent and received pings is recorded in fast memory. The recorded information includes indicators of when the pings were sent and received. The procedure of recording the information fills a structure for each destination. The structure is complete, for the purpose of current processing, when the destination has been pinged the predetermined number of times. The recorded information within the structure may be considered raw data. Once the chunk processing is complete, the raw data in the destination structures is written to slow memory by a printchunk routine 336.

It will be obvious to those skilled in the art that the above description of the preferred mping program, which is currently contemplated as being the best way of practicing this aspect of the invention, is but one of many methods of achieving the desired results. In fact, Matrix.Net has experimented with many other methods, which are currently less preferred, to achieve similar results less efficiently or with noteworthy disadvantages.

### Importance of Sample Size in Measurement

Now that mping, a preferred data collection process, has been fully explained, a few further considerations regarding sample size can be explored. Considerations with respect to sample size involve a tradeoff between adequate coverage and the problems of collecting and processing the resulting data. The beacons or the network on which they operate must not be significantly affected by the measuring packets. Otherwise, biases may be introduced into the data due to the data collection procedure itself. To avoid introducing bias, the user preferably performs quality control to ensure that the frequency of sampling and the number of destinations sampled are not so high that they significantly affect the data collection procedure.

There are other concerns about more frequent probing of certain destinations, to improve the time resolution for detecting certain types of events. This may involve continuous frequent measuring of smaller numbers of nodes or the turning on/off of measuring in response to event detection from the 15 minute samples.

Data Collection relates to measuring the destinations in the viewlists from one or more vantage points, called beacons. For each ISP, a list is created of several dozen to several hundred destinations that belong to that ISP's network. These lists are viewlists, described above. It should be noted however, that measuring does not rely solely on ICMP packets. Data collection commences when a viewlist is activated for one or more beacons. A beacon may run more than one mping process at a time.

Each beacon preferably scans each beaconlist every 15 minutes. In each scan, each beacon sends several measurement packets to each destination per beaconlist. A scan may entail measurement data of several different types, depending on the metric. Each packet is intended to elicit a response from its destination. The responses to groups of measurement packets (bongs) are recorded by the beacon as raw data.

Data collection occurs continuously through time, accumulating successive scans. Therefore, the data recorded about a particular metric, by a single beacon, for a certain beaconlist comprises a data stream. Data streams are periodically sent back to a data center, where the streams from multiple beacons are subjected to processing and statistical analysis for various displays. More generally, data recorded by a beacon about a particular metric for a certain viewlist is called a data stream. In practice, data streams for numerous viewlists are extracted from the data stream for a beaconlist. Data streams may also be combined across beacons, by methods such as the exemplary method, pingslice, described below.

The preferred embodiments of the present invention do not require instrumenting routers or other nodes. In particular, SNMP and packet snooping are not required. Instead, a few beacons are used to collect performance information at regular scan intervals from large numbers of destinations, using metrics based on standard Internet protocols. This tomographic approach permits a return of uniform metrics, even for non-subscriber ISPs. It also permits coverage of the entire Internet with detailed resolution to individual nodes.

A tomographic approach can be contrasted to end to end measurements. Various embodiments of the present invention may be referred to as tomography, because they use a relatively small number of beacons to measure a very large number of destinations, and those destinations are at all levels of the Internet, including routers, mail servers, FTP servers, and others, not just web servers.

Conventional approaches fail to give the same, detailed landscape view of the network of networks (the Internet) that the present invention provides. Application monitoring counts and tabulates traffic transmitted by different applications that use the network, but does no monitoring of the intervening network. Beacon-to-beacon or end-to-end measurements provide data only about paths between two specific points, rather than an entire network.

### Multiple Beacons

Measurement is preferably conducted from beacons placed at multiple vantage points, emphasizing coverage both in terns of routing topology and geography. Moreover, the scans sent from each beacon are synchronized so that each scan of viewlist destinations occurs at nearly the same time, rather than randomly throughout some interval.

The most important reason for measuring an ISP from multiple beacons is so that events can be detected with confidence by observing those events from multiple points of view. An event observed by only one beacon might be an artifact in that beacon; an event observed by several beacons is probably a real event. An artifact could be an overloaded local network link or an overloaded CPU on the beacon. While both of these artifacts are unlikely, similar artifacts could be the result of congestion in a link near the beacon inside its ISP. Real events of any size should be visible from multiple beacons. This is analogous to the way an image seen by only one eye could be a floater in the eye, while an image seen by both eyes is probably outside of either eye. The present invention provides a means to employ many eyes, or beacons, from which a variety of viewpoints of specific events are obtained. For example, if a congestion event occurs primarily in the northeastern region of one ISP and if that event was seen from only one beacon that is located in that region of that ISP, it might be mistaken for an artifact in or near that beacon. But because the event is seen from multiple beacons, both inside and outside of that ISP, it can be considered real with confidence. And thus, it can be determined that the beacon inside that region of the ISP is showing real data about the event, which can be used with confidence to more precisely determine the nature of the event.

### Data Processing

The scanning approach described herein often yields complex streams of data that must be combined and summarized for interpretation. Thus, a variety of flexible mathematical operations have been developed to provide useful information regarding network performance and events affecting performance. Each data stream carries ongoing information which is defined by four parameters: ISP, beacon, metric, and viewlist.

The data collected from mping will be used as an example to explain the nature of the processing method. The method can, of course, be used to process data from any data collection method that provides large amounts of data. The data collected by mping is initially in the form of raw data, which may be described as an array. Each record of the array is a destination structure, that is a set of data corresponding with a single destination on the beaconlist. The destination structure comprises information indicative of the destination, e.g. its IP address, and a number of lines of recorded data equal to the number of pings that were sent to each destination. Each line stores information indicative of one ping per destination, such as the time the ping was sent and the time the response was received. Since it has been found that six pings per destination are adequate to capture reasonably reliable performance data, six lines of data are used in this example. Data regarding the first ping (usually the first line of the structure) in the destination is removed because the initial ping produces different response characteristics than immediately succeeding pings.

The remaining five lines in each structure are processed to provide a data stream, which is defined by a beacon, a measurement process, and a beaconlist. In this example, a latency metric is calculated by finding the median value for the time elapsed between when a ping is sent and a corresponding response is received. Median values are used so that outliers do not skew the data. Only lines of data that include response receipt information is useful in such a latency calculation. Reachability for the destination is determined by examining the lines of data to determine whether any responses were received; if a single response was received, the destination is deemed reachable. Packet loss is determined using the number of responses received. If four echoes were received in response to five sent pings, packet loss is 20 percent. If the data stream was generated at a beacon, it is preferred that it be retrieved by a data processing center for further processing, although certain additional steps could be performed at the bacon.

A number of operations can be performed on the data stream defined by the beacon, measurement process and metric, the selection of which will depend on the ultimate display method being produced. Some of the many useful display methods are described below. For any display method which is to provide information specific to a particular interesting group of nodes, such as an ISP comparison, data regarding each interesting population must be extracted. As is more fully explained above, a viewlist is a list of destinations belonging to a single ISP or other interesting group of nodes. Thus, viewlists are used to extract data from a data stream defined by a beaconlist. This results in a data stream defined by a beacon, measurement process, and viewlist, which comprises the same data as the stream defined (in part) by a beaconlist, but for only a single population of interest.

If the viewlist from which the data stream was derived is large, the data stream comprises a vast amount of data. Thus, it is critical that a data reduction step be performed on the data stream. For each scan in the data stream that falls within a requested interval, the average metrics for each destination are used to calculate average values for each metric for the entire scan. In order to help eliminate outliers, medians are most often preferably used as the averages. Thus, a reduced data stream, which comprises a record for each scan, is produced. The information in each record includes information indicative of the scan start time and the average values of the metrics measured by the scan.

A network-wide assessment of performance is performed by combining multiple data streams. Pingslice is a new method for combining data streams. It provides for both the aggregation of multiple data streams, and the aggregation of data samples across regular time periods. This is a particularly significant step in the data analysis, as it significantly enhances the presentation of data.

Aggregation of data streams is the process of combining an arbitrary number of input time-series of performance data into a single data stream. This aspect of the invention is very useful for taking an overview of performance of an interesting group of nodes as seen by multiple beacons, or to provide an approximation for the combined performance of several related groups of nodes defined by distinct viewlists, or other sets of network components.

Preferably, the pingslice method operates on reduced data streams. Pingslice combines the data streams according to various parameters provided. Two important parameters are frequency and offset. The interval is the time period for which reduced data will be combined, which can be deduced from the input data streams. The frequency represents the resolution (in duration of time) of the output. That is to say, a frequency parameter of 15 minutes produces output data indicative of 15 minute time intervals.

Pingslice operates by defining periods of time, which will be called time slices. Each time slice is defined by the frequency and the offset. By way of example, where the interval is the hour beginning at 15:00 Greenwich Mean Time, the frequency is 15 minutes, and the offset is 5 seconds, the first time slice starts at 14:59:55. Subsequent time slices start at 15:14:55, 15:29:55, and 15:44:55. Where the interval divided by the frequency is equal to the scan time of the scans that ultimately were used to produce a record in the reduced input data, pingslice combines data from multiple beacons without changing data resolution. Where the interval divided by the frequency is a multiple of the scan time, the resolution of pingslice output is of different resolution than the input.

Pingslice operates on the incoming data by first sorting the records from each data stream by the scan start time. Each record is then allocated to the time slice in which its start time occurred. An average value for each of the metrics of interest is then calculated for each time slice, preferably by finding the median value of each metric for all the records in the slice.

For clarity, the above example will now be expanded using three example data streams. The data streams could have been collected from mping, and each contain records which represent the following information, in order: scan start time, latency (in milliseconds), packet loss, and reachability. The first datastream comprises the following records:

14:00:00 50 1% 99.9%

14:15:00 65 1% 99.1%

14:30:00 100 3% 99.8%

14:45:00 30 1% 99.9%

The second data stream comprises the following records:

14:00:15 55 5% 100%

14:14:59 35 1% 100%

14:30 20 3% 99.8%

14:45 110 1.5% 99.9%

The third data stream comprises the following records:

14:00:00 55 1% 99.9%

14:15:00 65 5% 97.1%

14:30:00 1000 3% 99.8%

14:45:00 25 1% 100%

Given the time slices indicated above, pingslice calculates average values for each metric, in this example, the following output medians:

14:00:00 55 1% 99.9% (for the time slice starting at 14:59:55);

14:15:00 65 1% 99.1% (for the time slice starting at 15:14:55);

14:30:00 100 3% 99.8% (for the time slice starting at 15:29:55); and

14:45:00 30 1% 99.9% (for the time slice starting at 15:44:55).

Pingslice then outputs this data, which represents the combined data from multiple beacons. As can be gleaned from the example, the format of the input and output data is identical, consisting of a time series of zero or more data records. The identical formats of the input data streams and the output data stream is extremely advantageous for a variety of reasons which should be obvious to those skilled in the art. Each data record consists of a time-coded sample of performance of one or more destinations from one or more beacons.

Depending on the nature of metrics being evaluated and other factors, preferred embodiments of pingslice may perform statistical analysis of each series of values for each time period. Analysis may be performed to calculate the minimum, first quartile, median, third quartile, maximum, mean, and standard deviation for each metric over the time period. Any statistical representation of the aggregate performance is then output.

Metrics such as latency are known to vary dramatically over a wide range of values. In order to deal uniformly with idiosyncratic distributional characteristics of different metrics, data summaries preferably utilize medians rather than arithmetic mean. This minimizes the effect of outliers, yet still allows for rigorous statistical comparisons.

### Event Detection

During the course of performance of the present invention, various forms of Internet performance data are gathered, as described in detail herein. The performance data collected can be evaluated in various useful ways.

A component of the present invention generally comprises a module for event detection. An event is usually understood as a performance anomaly. Generally, an event is the variance of performance data from a preselected parameter or set of parameters, called a threshold. Once the performance data varies from preselected threshold values, an event is recorded. Events can be measured, recorded and evaluated by the method of the present invention in several ways, as discussed in detail herein.

As described in greater detail below, the event detection methods of the present invention provide a great degree of flexibility. Numerous parameters can be set to determine thresholds triggering the detection of an event, based upon a user's preferences.

### GENERAL METHOD: OVERVIEW

The general method of event detection comprises analyzing an input stream of Internet performance data in order to determine, in real time if necessary, the existence of anomalous performance events. Historically, performance events are identified by individuals reviewing collected data, generally after the fact, using ill-defined criteria for determining that an event has occurred. Such a system is completely unsatisfactory for determining the occurrence of events in a dynamic computer network system.

The event detection methods of the current invention solve a number of problems described herein. The event detection methods of the current invention allow anomalous performance events on the Internet to be detected automatically and in real time, using flexible, parameterized, but precise, criteria for recording the occurrence of an event. The general event detection method automatically detects the type of data stream being analyzed and employs an appropriate event detection method for the given type of data.

Automatic detection of performance problems in the Internet has been a desirable goal since at least the advent of the World Wide Web in the early 1990's. One way to accomplish this is to analyze time series data collected by methods such as those described herein to automatically detect anomalous performance events. However, anomalous events are sometimes difficult to define and dependent on the type of data examined and the context in which a particular time series is collected. Hence, a technique for detecting events that can be applied to a wide range of such definitions is provided.

One approach to automatic event detection is to measure the data for sudden large increases or decreases in the value of a measured metric, such as the mean latency or packet loss encountered in measuring a set of nodes, or the percentage of those nodes that are reachable during a particular time interval. However, merely comparing consecutive values of such a time series is inadequate since the resulting detector is very sensitive to high frequency noise in the data and thus causes frequent signaling of spurious events. The problem of noise can be addressed by the use of a low-pass filter such as a sliding average over a specified window of data samples, although the appropriate window size will depend on the noise characteristics of the data. The resulting technique is still only sensitive to the magnitude of changes in the amplitude of the signal, however, and it requires knowing in advance how much change in amplitude will be significant.

Another approach allows a very general low-pass filter to be employed for noise suppression in the analysis. An arbitrary filter kernel can be specified as an array of weights to be associated with a series of sample points as the filter is applied.

Further noise immunity is obtained by finding the best least-squares line fitted to a specified window of previously filtered data, and using the slope of this line as an indicator of the existence of an event. When the slope of the line crosses a specified slope threshold value, an event is signaled. This avoids the need to know the amount of change in amplitude necessary to constitute an event by instead identifying an event whenever the rate of change of the values measured in a time interval window exceeds some threshold, regardless of the amplitude eventually reached.

The present invention relates, in another respect, to the measurement of event duration, in which specific criteria for determining the start and end of an event are employed. The criteria used for determining event start and end points are distinct, and are based on computing weighted sums of a variety of criteria and comparing these to threshold values. These include but are not limited to the criteria used in the solutions mentioned above, and can be applied in various ways to define event starts and endings. In addition, distinct filter kernels for low pass filtering can be used in processing the start and ending points of an event, as can distinct windows for further processing such as line fitting. By employing a state machine which can behave differently when an event is actively occurring, as distinguished from when no events have begun, a much more dynamic and useful scheme for reacting to, measuring and recording anomalous events in the computer network results.

Whether or not an event has occurred depends on several factors. As mentioned above, events can be defined by the setting of certain parameters which define thresholds. These thresholds are predetermined values which can be used to determine whether an event has occurred. The ability to set thresholds, and the ability to select from several different threshold parameters, is critical to the detection of events in a dynamic system.

Thresholds are determined empirically. The setting of a given threshold is dependent on the application-specific meaning of an event in a given circumstance. The choice of a threshold setting will determine what the meaning of an event is to the system. Thus, thresholds must be set in such a way as to react to phenomena and performance data measurements of interest to the user. By way of example and not by way of limitation, using the filter or evaluation methods described in detail below, a user may seek to have an event flagged whenever the median latency, measured in milliseconds, for a viewlist increases by 100% over an hour. In such an example, a filter time interval window of one hour would be used, a line fit window of one hour would be used, and a slope threshold of 2 milliseconds/hour would be used.

One method of evaluating the performance data and detecting events is to measure the absolute value of the given metric and signaling an event if this value falls into a specified range. This method is referred to herein as the absolute value method.

Yet another method of the present invention for event detection employs low pass filtering using a sliding window averaging scheme. A sliding average value is computed over a sequence of windows of a predetermined size on the input time series. Consecutive values of this sliding average are compared, and when the difference between the measured values exceeds a predetermined threshold, an event is flagged.

Another event detection method is to apply one or more filters to individual data streams to identify events that may indicate performance anomalies. This is referred to as the filter method. The filter method fits a best least squares line to the output of the filter. The slope of the fitted line is compared to a threshold slope to determine if an event has occurred.

Another filter scheme is designed to detect anomalies of longer duration. This is referred to as the evaluation method. Threshold parameters are selected to define the start point and end point of an event. Once an event is triggered, no further events will be recorded until the performance data values reach a reset threshold signaling the end of an event.

All forms of automated detection described herein provide a basis for launching additional measuring (from more beacons and/or at more frequent time intervals) when anomalous conditions arise.

Once the initial event detectors are in place, the process of working with users and simulations can begin, in order to assess the correlation of the types of events detected with the phenomena of interest to the customers. Given the amount of information available from data collection processes, distinguishing a wide variety of phenomena is contemplated.

A detailed description of the preferred embodiment of each of the methods of event detection follows.

### EVENT DETECTION: ABSOLUTE VALUE METHOD

The absolute value threshold is one method of event detection. Using this method, an event is recorded when the average value of the data in a particular window is outside of a predetermined threshold range. Any measured data falling outside of this range, crossing the threshold, triggers an event to be recorded.

### EVENT DETECTION: SLIDING AVERAGE METHOD

One method of the present invention for event detection employs low pass filtering using a sliding window averaging scheme. A first sliding average value is computed for a first sequence of data points comprising a sliding window of a predetermined size on the input time series. The sliding window then moves incrementally forward, adding a new data point, and dropping the oldest data point in the input time series. A new sliding window average value is computed for this new series of data points. The new sliding window average is compared to the first sliding window average. If their ratio exceeds a predefined ratio threshold, and if their difference exceeds a predefined difference threshold, and if the value of the most recent average exceeds a predefined minimum value threshold, an event is flagged at the time interval corresponding to the current input data point.

The parameters utilized in this method are the size (number of consecutive time interval samples) of the sliding window, the amplitude threshold that indicates an event, the absolute minimum current data value that can trigger an event, and the absolute minimum difference between the current measured data value and the preceding sliding window average that can trigger an event. The amplitude threshold defines a ratio of the current sliding window average to the preceding sliding window average that must be exceeded for an event to be identified. The minimum data value and minimum difference between the current data value and the preceding sliding window average are absolute values rather than ratios. These parameters can be set to prevent performance anomalies from being flagged during quiescent periods when small variations of data values would otherwise cross the amplitude ratio threshold. The sliding average window is essentially a low pass filter whose bandwidth cutoff can be varied by changing the window width. This allows smoothing of the data before events are recorded, but this strategy by its very nature detects events that are characterized by single data points of relatively large amplitude.

By way of illustration and not limitation, six consecutive data points have a designation of DP1, DP2, DP3, DP4, DP5 and DP6. Using the sliding average method, a first average is taken of three consecutive data points (where (n) equals three data points), for example DP1, DP2 and DP3, comprising a first sliding window. A second average is taken of DP2, DP3 and DP4, the next subsequent sliding window. If the ratio of the second average to the first average exceeds a predetermined threshold ratio, and if the second average exceeds a threshold minimum data value, and if the difference between the second average and the first average is greater than an absolute minimum difference threshold, an event is flagged. This process continues, and a third average is taken of DP3, DP4 and DP5, the next sliding window. The third average is compared to the second average obtained from DP2, DP3 and DP4. The process can be repeated until the data points are exhausted.

The system is dynamic, so that the sliding window moves across the time data series, and continually compares the median values of a given window to the average median value of the sliding window.

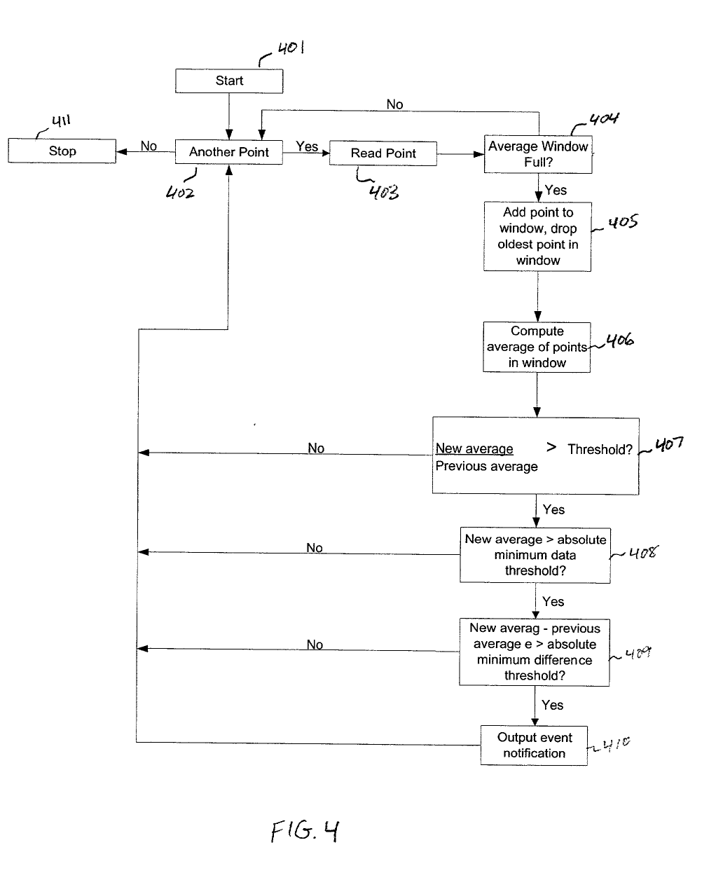

A schematic of another embodiment of the sliding average window method is shown in FIG. 4. At the start point 401, a data point, referred to as “Another Point” 402 in FIG. 4, enters the system and is read 403. If the selected series of data points defining the sliding window to be used to calculate the sliding average, referred to in FIG. 4 as the “Average Window” 404, is not full, the data point is added to the Average Window, and the oldest data point in the window is dropped 405. The average of the data points in the Average Window is computed 406. The average calculated can be compared to several thresholds. As shown in FIG. 4, if the ratio of the new average obtained to a previously measured average is greater than a preselected threshold range 407, the average is measured against another threshold 408. As shown in FIG. 4, the new average is then compared to an absolute minimum threshold 408. If the new average is greater than the absolute minimum threshold 408, the new average is further processed to determine whether an event has occurred. Then the value of the previous average is subtracted from the value of the new average 409. If the difference in the previous average and the new average is greater than an absolute minimum difference threshold, an event is recorded, as shown in FIG. 4, “Output event notification” 410. The series can continue until all data points have been processed, and the system is stopped 411.

### EVENT DETECTION: FILTER METHOD

Another event detection method of the present invention allows a very general low-pass filter to be employed for noise suppression in the analysis of performance data. A filter kernel is specified as an array of weights to be associated with a series of sample points as the filter is applied. Further reduction of noise may be obtained by finding the best least squares line fitted to a specified window of filtered data, and using the slope of this line as an indicator of whether an event occurs. When the slope of the fitted line crosses a specified threshold, an event is signaled. This avoids the problems associated with attempting to measure events by measuring the change in amplitude between a data value and a threshold value, instead identifying an event when the rate of change of the time series exceeds the threshold, regardless of the amplitude.

The desired time series data is read into a detector, either in advance or incrementally. Once a number of data points equal to the size (n) of the filter window are available, the filter specified by an array of (n) weights is applied by multiplying each weight by the appropriate data point and summing the results to produce the first filtered data point as output. The next point is read in, the filter is applied to the most recent (n) points read, producing the next filtered output point. This process is repeated until a number of filtered points equal to the size of the line fitting window (m) have been produced. Next, a least squares line is fitted to the filtered points of the most recent window (m). If the magnitude of the slope of the resulting line exceeds a predetermined slope magnitude threshold, an event is recorded. This process continues until the input time series is exhausted. The following criteria can all be varied according to the type of input data being examined: size of the filter window, the filter kernel specified as an array of weights, the size of the line fitting window and the slope magnitude threshold for signaling an event. By varying the listed criteria, events can be recorded with precision and control from a dynamic computer network system.

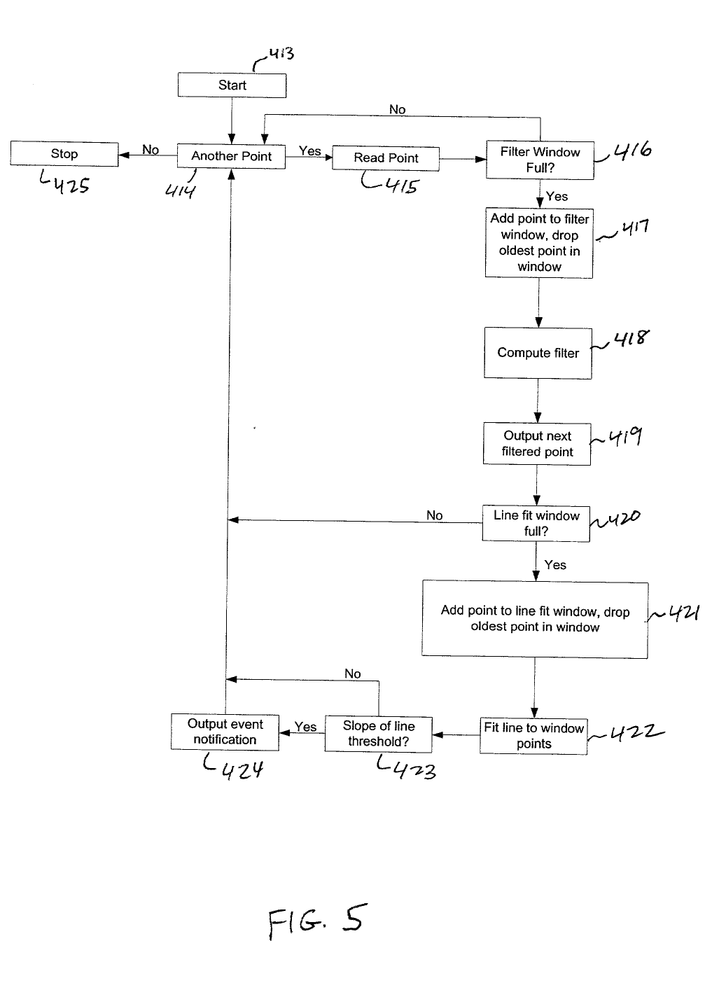

A schematic of a preferred embodiment of the filter method is shown in FIG. 5. At the start of the process 413, a data point, referred to in FIG. 5 as “Another Point” 414, is read into the system 415. If the filter window of a preselected size is full 416, the new data point is added to the filter window, and the oldest data point in the filter window is dropped 417. A filter kernel is applied to the data in the filter window, shown in FIG. 5 as “Compute filter.” The result of applying the filter kernel to the data in the filter window is shown in FIG. 5 as “Output next filtered point” 419. If a line fit window of predetermined size is not full, another point 414 is added. If a line fit window of predetermined size is full 420, the filtered point is added to the line fit window, and the oldest point in the line fit window is dropped 421. A best least squares line is fitted to the filtered points in the line fit window 422. If the slope of the resultant line exceeds a predetermined slope threshold or slope threshold range, shown in FIG. 5 as “Slope of line threshold?” 423, an event is recorded 424. The process can continue until all data points have been filtered, and the system is stopped 425.

### EVENT DETECTION: EVALUATION METHOD

The evaluation method for event detection according to the present invention focuses on event duration, in which criteria for signaling the start and end of an event are employed. The criteria used for defining an event's start and end points are distinct, and are based on computing weighted sums of a variety of criteria and comparing these to threshold values. These include but are not limited to the criteria used in the absolute value method, filter method, and sliding average method noted above, and can be applied in distinct ways to define event start and end points. In addition, distinct filter kernels for low pass filtering can be used in processing the data measuring event start and end points, as can distinct windows for further processing, such as line fitting. By employing a state machine that behaves differently when an event is actively occurring, as compared to when the system is stable and no events have begun, a much more dynamic and reactive scheme for measuring and recording anomalies on a computer network system results.

As with the filter method, a single data stream is passed through a low pass filter with a specified frequency cutoff. A variety of filter types can be used in order to achieve desired control of the spectrum of the filtered data. Rather than defining an event as an amplitude spike as in other methods, this filter will attempt to identify an event as the start of a longer duration anomaly in the performance data being measured. To distinguish such events from long-term upward trends, a slope threshold is used to flag events. First, a least squares line is fitted to data points from a window of the filtered data. An event start point is signaled if the slope of this line exceeds a threshold slope value. Once an event is signaled, no further events will be signaled until the criteria for determining the end of an event are met. The system is then considered to be in a state where an event is actively occurring.

The end of an event is determined by first filtering the input data using a filter kernel and window size distinct from those used for the criteria for signaling the start of an event. A least squares line is fitted to this filtered data using a window distinct from that used for fitting the line for the event initiation criterion. The end of an event is signaled if the slope of this line is within a specified range and if the variance of the points within the event termination or end filter window is within a specified range. The system is then considered to be in a state where an event is not actively occurring.

The evaluation method described herein will avoid frequent triggering due to data variations during an event of longer duration. The parameters which can be controlled in employing the evaluation method are the width of the filter kernels for the start and end event signals, the width of the least squares windows for start and end event signals, the event and reset slope thresholds, the termination variance, and the type of low pass filter to be used (Box, Butterworth, etc.).

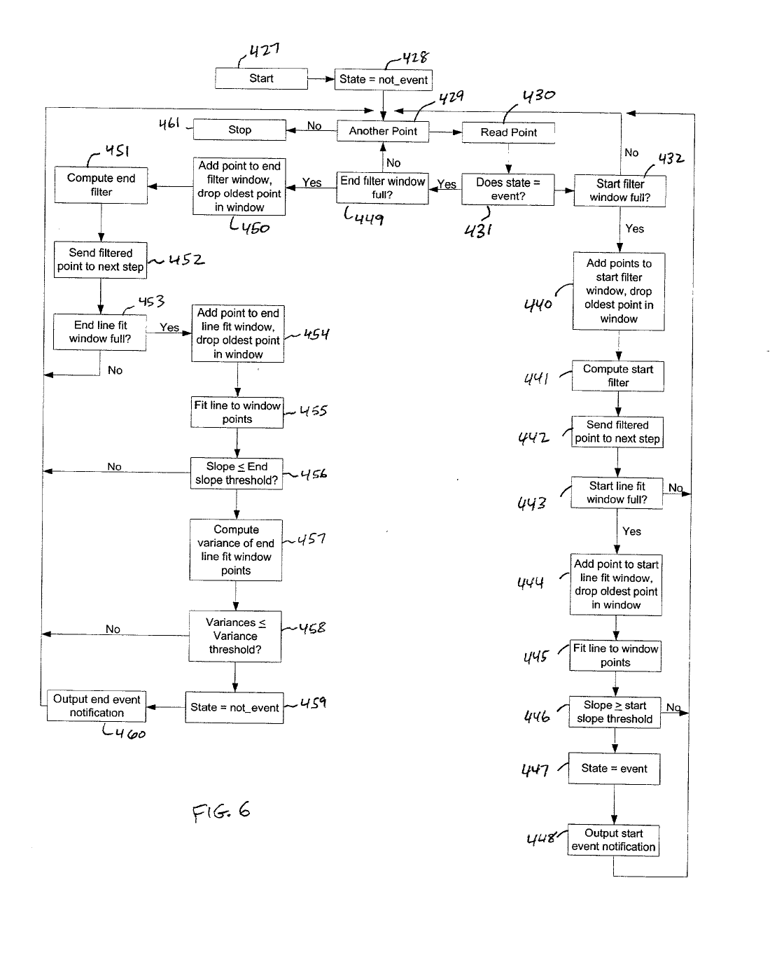

A schematic of a preferred embodiment of the evaluation method is shown in FIG. 6. At the start of the process 427, the state of the system is such that there are no active events 428. A data point is added to the system 429, and the data point is read 430. If the system is in a state where no events have been detected, shown in FIG. 6 as “Does state=event?” 431, it is determined whether the start filter window is full 432. If the start filter window is full, the new data point is added to the start filter window, and the oldest data point is dropped from the window 440. A start filter kernel is applied to the start filter window, as described above, and start filtered data points are produced 441. The filtered data point is forwarded to the next step in the process 442, and it is determined whether the start line fit window is full 443. If the start line window is not full, another point 429 is added. If the start line window is full, the filtered point is added to the start line fit window, and the oldest data point in the window is dropped 444. A best least squares line is fitted to the filtered start line window points 445. If the calculated slope of the fitted line is greater than or equal to a predetermined slope or slope range 446, the system is considered to be in the state of an actively occurring event 447. The start of an event is recorded, shown in FIG. 6 as “Output start event notification” 448.

Once the system is in a state of an active event, the process shifts to determining the end of an event. Thus, data points are read 430, the system is in the state of an event 431, and it is determined whether the end filter window is full 449. If the end filter window is full, the data point is added to the end filter window, and the oldest data point in the end filter window is dropped 450. An end filter kernel is applied to the end filter window, as described above, and end filtered data points are produced 451. The filtered data point is sent to the next step in the process 452, and it is determined whether the end line fit window is full 453. If the end line fit window is full, the new filtered data point is added to the end line fit window, and the oldest data point is dropped 454. A best least squares line is fitted to the data points in the end line fit window 455. It is determined whether the slope of the fitted line is less than or equal to a predetermined end slope threshold 456. If the slope of the fitted line is less than or equal to the predetermined end slope threshold, the variance of the end line fit window points is computed 458. The variance is compared to a predetermined variance threshold 459. If the variance is less than or equal to the variance threshold, the system is then considered to be in a state where an active event is not occurring, shown in FIG. 6 as “not_event” 459. The end of an event is recorded, shown in FIG. 6 as “Output end event notification” 460, and, if there are no further points, the system comes to a stop 461. If performance data continues to enter the system, another point is added 429, and the process begins again.

### Data Analysis

Once an event has been detected, isolation of problems to specific servers, routers, links, or interconnection points can be accomplished with various methods related to the present invention. Upon detection of an event, specific data for a time frame surrounding the troublesome point in time is provided to an analysis program. Statistics regarding the data are then compiled, sorted in a way which is meaningful to the user and displayed.

For a given performance metric, a number of statistics, such as high, average, most recent value, LMS slope, overall Delta, highest sample Delta, latest sample Delta and the like, may be determined for the metric for a time period.

Further, “by destination”, (i.e. data for which the individual nodes from which the data was collected are identifiable) data for the scan in which an event began, or other “by destination” data containing information for the appropriate time period can be sorted by worst results per performance metric, such as highest latency, highest packet loss, etc. The destinations scanned for which the worst performance data was observed are considered the problem nodes, often routers. Routers that show up as problems as observed from several beacons are of significant interest. Once problematic routers are known, performance leading up to the problem can be graphed and investigation of previous problems performed. The results of such analysis methods may be used by data presentation methods such as those described below. Further, viewlists can be modified or new vielists can be created to examine the performance of the troublesome routers and the nodes adjacent the troublesome routers in greater detail in the future.

### Data Presentation

Many novel methods of data presentation have been developed in connection with the system. Interpretation of the following presentations provides insight into the performance of a subscriber ISP and competing ISPs, and of the Internet at large. The system of the current invention provides information that aids in: detecting specific network problems quickly, both inside and outside the subscriber's network; displaying historical performance; predicting problems such as increasing congestion in certain links or need for more interconnections; and assisting with capacity planning characterization of performance-related events.

One type of data presentation method is Ratings. Ratings uses a novel method of displaying a great deal of information about one or more interesting groups of nodes in a way that allows a user to rapidly comprehend network performance allow. Due to its ability to present a massive amount of data in a very organized way, Ratings is ideally used for comparing the performance of at least two ISPs.

Ratings is a tabular display of Internet performance data, designed to present summaries of performance data in a logical, easy-to-read fashion. Ratings uniquely uses distinct metrics, such as latency, packet loss, and reachability, which may be measured by the methods described above, to characterize Internet performance. It is noteworthy that other metrics may be used as well. The performance characterizations are presented over a number of different time frames. Therefore, the volume of data to be presented is significant.

Although the Ratings table uses reduced data, the information displayed is still complex. This method of comparing ISPs is unique in that it allows comparisons to be made according several metrics. Use of more than one distinct metric makes possible more meaningful comparisons than would be possible using only a single figure of merit for the performance of an ISP.

To make this data easy to interpret, a tabular format is employed with a careful arrangement of the data on each cell of the table to allow rapid comparisons to be made. Each ISP or other group of nodes to be rated is represented by a column in the table, having several individual statistics presented for that entity. Since the entities can be compared according to any of these statistics, it is very difficult in a single display to make all such comparisons easy for the user to do.

Ratings has a feature designed to facilitate rapid assessment and useful interpretation: the ability of the viewer to choose different orders of presentation for the summary data. The available orders of presentation, or sort options, reflect the organizational structure behind the data collection as well as the three distinct metrics measured. Each viewer may select the order that reflects appropriate comparisons, so that selection and order of sorting can be done according to any one of the performance metrics (e.g., latency, packet loss, reachability), geographic regions of various sizes (e.g., North America, Europe, Africa, U.S. States, Canadian provinces, European countries). If desired, ISPs may also be grouped by the type of service they emphasize. Thus, Ratings provides a display that allows a viewer to assess the performance characteristic most relevant to the viewer's individual concerns very quickly.

Ratings presents summaries of data from multiple performance metrics on one table, while still allowing comparison across ISPs. This is accomplished by designing the table to have one line for each ISP, and one column for each metric. Summaries from multiple time period are included within a single cell for the relevant metric and ISP. Each cell defines five points consisting of the visual center plus each of the four comers of the cell in which to place values. The first value in the cell will be in the center position. Additional (comer) points may be filled with values as needed clockwise from the lower right. Preferably, the values represent time frames ranging from the previous 24 hour period to the previous 28 day period. Most preferably, the values include indications of performance for the past day, 7 days and 28 days.

This novel design for a Ratings table reduces the apparent visual clutter within a cell so that it is possible to draw focus to a particular value, while retaining readability of the remaining values. The value to be highlighted is placed at the center of the cell, and may be emphasized with boldface characters. Other values, those in comers, may be printed in a smaller font, and are not boldfaced. If displaying only three numbers for a metric, such as one day, one week, and one month data, it is preferable to place the one day data in the top center, the week in the bottom left comer, and the month in the bottom right comer of each cell.

A preferred embodiment of Ratings facilitates comparisons among ISPs along a given statistical metric by sorting the entire table according to the selected metric. Since this will make comparisons along other statistics more difficult, this sorting should be dynamic and user controlled so that the user can quickly compare ISPs along each of a set of distinct statistics.

Ratings also provides a color coding scheme for the backgrounds of cells that provides an indication of performance levels. Threshold values may be used to color the cell, or more preferably, the portion of the cell where the appropriate value lies. The threshold values are determined in part by the range of values Ratings is reporting at any particular time. By way of example, latency may be coded as follows: red for 150 ms or more; yellow for less than 150 ms, but greater than or equal to 70 ms; and green for less than 70. Packet loss may be coded red for 5 percent or more; yellow for less than 5 percent but greater than or equal to 2.5 percent; and green for less than 2.5 percent. Reachability may be coded red for less than 95 percent; yellow for less than 99 percent but greater than or equal to 95 percent; and green for 99 percent or more.

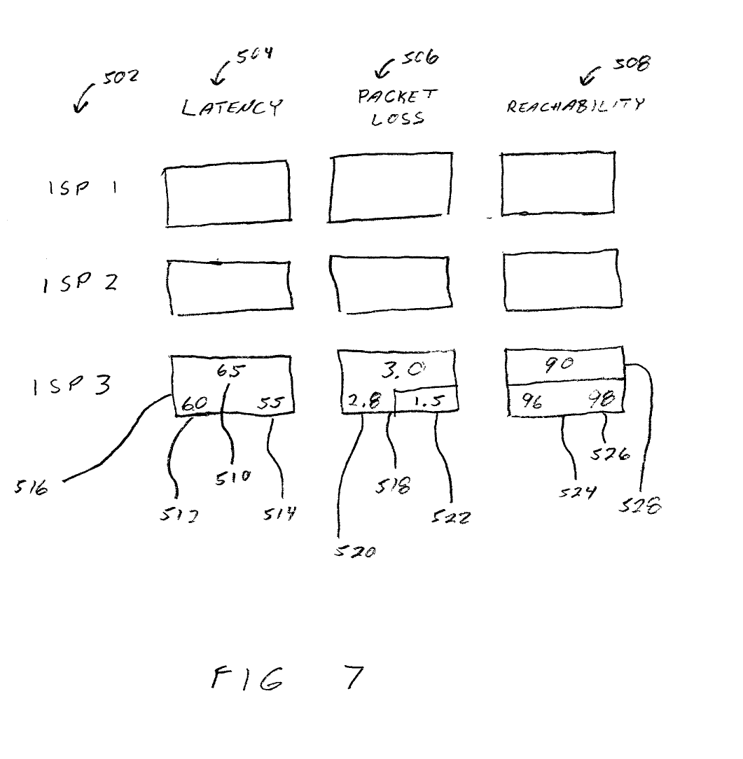

FIG. 7 shows an example of a preferred Ratings table (having values filled in for ISP 3 only). ISPs are listed in a left hand column 502. Latency is represented by a second column 504, while packet loss and reachability are represented by third and forth columns, 506 and 508 respectively. The values for ISP 3 are provided in the Figure to show that values for the past day 510 are presented in the center of the top of a cell. Values for the past 7 days 512 are presented in the bottom left and values for the past month are in the bottom right 514. Using the example thresholds defined above, cell 516 is fully shaded in green. Cell 518 is divided into a yellow portion 520 and a green portion 522. Cell 524 is divided into a yellow portion 526 and a red portion 528.

Data may also be presented in graphical formats for ready comprehension. All of these graphs preferably plot the performance of two or more ISPs on a metric versus time graph. Rolling 24-hour presentations may be generated hourly, showing 24 hours of packet loss, latency and reachability as viewed from multiple beacons with a resolution of 15 minutes (where a 15 minute scan time has been used in the Data Collection process). These rolling graphs can show trends within and changes within an hour of them occurring. In practice, however, it has been found that generating graphs on a daily basis is adequate to provide information suitable for most users.

Rolling 7-day graphs are generated daily, showing 7 days of packet loss, latency and reachability as seen from an aggregated view from a number of beacons with a resolution of 15 minutes (where a 15 minute scan time has been used in the Data Collection process). The weekly view provides an excellent presentation of regular medium-term trends (such as the common variations over each 24-hour period).

Latest hourly graphs are generated hourly, showing the last hour's packet loss, latency and reachability, as seen from an aggregated view from all the beacons with a resolution of 15 minutes (where a 15 minute scan time has been used in the Data Collection process). The hourly presentation provides a high resolution of short term trends and changes within an hour.

Latest daily graphs are generated daily, showing the previous 24 hours (midnight to midnight, GMT) of packet loss, latency and reachability as viewed from each individual beacon and from an aggregated view from all the beacons with a resolution of 15 minutes.

Multi-ISP graphs may be generated hourly, showing 24-hour rolling graphs of packet loss, latency and reachability for each of two or more ISPs as viewed from each of several beacons.

The various presentations allow a direct comparison of performance between different ISPs over the same time periods.

Another novel aspect of data presentation is Shaded Display. The results of the event detection methods described above may be used to visually display anomalous performance events on the Internet. In order to inform customers that such an event is taking place or has taken place, a graphical display format that indicates the type, timing, and duration of the event in an easy to interpret way has been invented. This invention comprises a scheme for displaying such events as shaded regions underlaying a line graph displaying the data from which the event was automatically detected. The timing and duration of the event are obtained from the output of event detection methods. The line graph may be generated from input to or output from these methods. The graph should be provided with an indication of the type of data that the graph represents, and is preferably augmented by notations on the graph as needed.

Using methods such as those described above, data is obtained and processed to produce various performance metrics, the examples provided above being latency, packet loss, and reachability information, as streams of summary data points, where the data is summarized for a set of Internet nodes. This processed data is analyzed as a time series or stream by the event detection algorithms which automatically determine when anomalous performance events begin and end. For each such detected event, the detection algorithm outputs an indication of the event starting time and to which performance metric the event relates, and its ending time when it ends. These indicators are used by display algorithms to produce a line graph of the data stream being analyzed, along with a colored, shaded underlay bounded by the event's starting time on the left, its ending time on the right, and using a color chosen to facilitate ease of reading to provide the shaded overlay between these bounds. A shaded overlay could also be used, but is not preferred because it would obscure the graph. The interval overlapped by the shaded region is the interval over which the event is defined to have occurred. Left and right boundaries are highlighted by vertical lines, and marker tags identifying the event and providing other informative information about the event are overlaid on the graph in a way that makes clear with which event they are associated. These marker tags may be placed on or near the left and right boundaries to further define the time an event begins and ends, or provide information indicating the magnitude of the event, or other useful information of interest.

To ensure that the display does not obscure the original data, the process designs the shading as a background to the graph of the original data so that it does not obscure any other displayed feature. The process employs a complementary color for shading so that both the shading and the other features show up clearly.

The Shaded Display process provides a way of making the display simple and uncluttered. The process carefully places tags containing information about the event so that they do not obscure other information on the graph. It is preferable that numerous overlapping event intervals are generally not displayed on the same display. Thus, a user can read the display to quickly identify an anomalous Internet performance event and relate the event to the data from which it was identified.

Yet another aspect of data presentation is a novel automated alert system. This is an “active” presentation system. Users who benefit from the presentations of data described above may not constantly measure the available displays. Thus, it is desirable to automatically alert users to anomalous performance events that are important to them. A preferred alert method is fully automated and sends email notifications to users, the contents of which include the results of event detection or analysis methods, such as those described above.

The preferred method allows users to specify which events should trigger notifications. This is possible by providing an automatic user feedback mechanism that allows a user to request that notifications not be sent of future events similar to each one for which they receive a notification. This allows the customer to incrementally refine the types and severities of events for which they wish to receive notifications.

More specifically, the performance of groups of interesting nodes on a large network is measured by methods such as those described above. Users of the event monitoring service indicate in advance that they wish to be notified of the details of a given type of performance event. The customers are automatically sent email containing the results of a detailed event analysis when such an event is detected. Customers can refine the process of defining events that merit notification by responding to each event notification with a message indicating whether the event was worth notification or not. This information is retained and used in later invocations of the event notification method to determine whether or not to notify the recipient of later events.

To implement the method, the event types to be used to trigger alerts and the desired recipients of the alerts must be defined. Detection methods, such as those described above, analyze time series data to determine whether an event of the type defined for notification is occurring for a viewlist or combination of viewlists. Should such an event be detected, detailed analysis is performed. In the case of a reachability event, analysis may include using a per destination type data stream (see Data Processing, above) enumerating the nodes in the set that cannot be reached from one or more appropriate beacons at the latest time interval for which a measurement is available. For packet loss and latency events, the analysis may involve determining the nodes in the set that are affected by the event and sorting them by the severity with which they are affected by the event, by their geographic location, or possibly by other relevant criteria. This information is composed into an email message describing the event. Associated with each potential recipient of event notifications is a file containing the severity threshold above which they are to be notified of events of each type. If the severity of the current event, as measured by the event detection method, is above the threshold for a recipient on the list, the event notification message is sent to that recipient, otherwise it is not sent.

As previously noted, recipients can reply to the email containing the notification indicating that they do not wish to be notified of future events similar to the current one. If a reply containing the current event identification is received, the file containing the event notification threshold for that recipient for events of the same type as the one identified is updated by setting the appropriate threshold equal to the sum of the value of the identified event and a predefined increment for that event type.

### Data Correction

Any data measured by data collection methods compatible with the current invention may be corrected for geographic distance or observed minimum latency. This aspect of the invention relates to Internet topology, which differs from terrestrial geography. By way of explanation, the shortest distance between two points in a plane is a straight line. But everyone realizes that the road between any two locations is not likely to be a straight line. Paths traveled by Internet data are much more likely to be indirect than roads. Often packets move between source and destination via a circuitous route. Sometimes this is because that route is actually more efficient, due to congestion from other traffic on more direct routes (also familiar to anyone who commutes) due to the nature of the Internet, which is not made up of direct connections between remote points. Other times, indirect routes arise from the fact that packets must cross ISP boundaries to reach their destination, and their options for paths of travel are limited by political and economic, rather than engineering considerations.

It is also noteworthy that the path from point A to point B is not necessarily the path from point B to point A. While data collection methods, such as those described herein, can measure “length” of the round trip point A to point B to point A, it is important to keep in mind the potential for asymmetric routes, such as a packet going from A to B, and returning via B to C to D to A. It must be kept in mind that the path between any source and destination pair is made up of links and nodes (mostly routers). While the distances that are traversed by links may be long, the transmission rate of packets over the links is extremely fast, limited only by the speed of light.

Geographic distances have a significant effect on latencies over paths that span a substantial portion of the globe, and so there may be a substantial difference between the performance intra-continentally and inter-continentally. These effects on latencies are, however, generally constant. A source of variation in latencies is the time it takes to process packets through the routers they meet along the path.

Because it is distance dependent, latency as a single metric indicating quality of service provided by an entity on the Internet, as seen from one beacon, can be somewhat misleading. If latency to a set of servers in Europe, for example, is measured by observers in North America, the numbers will almost certainly be much higher than the latency measured by the same observers to nodes in North America simply due to the greater distances traversed by packets in the former case. Higher latencies in this case do not mean that the European nodes are providing bad service, just that they are farther away.

The geographic distances between nodes on a viewlist and the beacon measuring performance on those nodes may be used to correct the observed latency for data collected by methods such as those described herein. This may be accomplished by first determining the geographic distance traversed over each link in the route between the beacon and a node. This determination may be performed using methods, which are well known to those skilled in the art, of calculating great circle distance between the two points, which are each defined by latitude and longitude. A correction factor may be found by computing the time taken to traverse the calculated distance by taking the product of the speed of light in the links and the applicable distance. This is then subtracted from the measured latency from the beacon to the destinations to produce a latency measurement that has the most basic geographical element removed, thus making latencies for remote ISPs more comparable.

Exact distance and speed of light calculations to determine constant latency due to routing distance is difficult unless routing distances are known accurately. Various methods can provide reasonable accuracy in computing these distances for nodes with significant geographic separations along the routes connecting them by using a multi-pronged approach to determining the location of a node to within a single ZIP code. One such ZIP method is to maintain a localization database which may be used in computing constant distance correction values. Each node in the Internet is associated with the ZIP code within which it resides, either by looking up this information in the domain registry, inferring it from portions of the hostname referring to locations (such as airport codes), or calculating it from connectivity to and latency from other localized nodes. Using the distance estimates from this database and an estimate of the speed of light in communication media, for each beacon and destination the minimum speed of light delay for the great circle distance between each beacon and destination is computed, and subtracted for each latency measured for that beacon and destination pair, before all the other data reduction is performed.

Another way of differentiating the constant latency from the varying latency is to determine a constant baseline latency from a beacon to each destination in a set of nodes being measured by using the minimum latency observed over an extended period of time as the baseline. This baseline can be subtracted from the measured latency at any given time to determine a figure of merit that is a more useful for certain purposes as an indicator of the performance of the measured destinations than is raw measured latency.

The baseline may be computed by taking the minimum observed median of a metric for an extended period of time, usually at least a week and perhaps as long as a month. Each time a new raw sample is taken, it is compared with the current baseline. If it is smaller than the current baseline, the baseline is made equal to the new sample, and the variable latency for the sample is set to 0. Otherwise, the variable metric value for the sample is set to the raw metric value minus the baseline value. To create an aggregate variable latency from a set of nodes on a viewlist the variable latencies for each node are averaged, just as for the raw latencies.

A variation on this scheme involves directly computing baselines for the entire set of measured nodes. In this case, a baseline for the average latency for the set of nodes is computed by taking the minimum value for the average latency over an extended period of time. If the average latency for the current sample is smaller than the baseline, the baseline is made equal to the current average latency and the average variable latency is set to 0. Otherwise the average variable latency is set to the average latency minus the average baseline.

By applying latency correction, performance metrics reflecting only the variable part of the latency may be used by the methods described above.

A preferred method for measuring the performance of a large computer network, such as the Internet, has been described. Various novel methods of preparing sampling lists, collecting data, processing data, and presenting data have also been described. It should be understood that the present invention may be embodied in other specific forms without departing from the spirit or essential attributes thereof. Accordingly, reference should be made to the appended claims, rather than to the foregoing specification, as indicating the scope of the invention.

What is claimed is:

1. A method for measuring the performance of at least a portion of a computer network, the method comprising the steps of:
providing one or more sampling lists, each sampling list identifying one or more nodes representative of a group of nodes of interest;
sending signals to a relatively large number of nodes identified on the one or more sampling lists in a relatively short time;
receiving signals from responding nodes on the one or more sampling lists;
recording raw data indicative of the corresponding sent and received signals;
reducing the raw data to data streams indicative of the performance of the nodes; and
presenting information derived from the data streams, the information being indicative of the performance of one or more of the groups of interest.

2. The method of claim 1 wherein the providing step further comprises the steps of,
gathering data regarding topology of the network,
classifying nodes in an organized way based on the gathered data to create one or more lists of nodes for each group of interest,
selecting nodes representative of each group of interest, and
creating the sampling list for each group of interest from the selected nodes.

3. The method of claim 2 wherein the gathering step further comprises the steps of,
obtaining a population survey that lists substantially all of the nodes on the network,
extracting a list of main domains from the population survey,
recording an example node for each main domain, and
identifying the routes through which information travels between the example nodes and a beacon.

4. The method of claim 2 wherein the selecting step further comprises the step of trimming the one or more lists of nodes for the one or more groups of interest by excluding from consideration those nodes which are not important to the performance of other nodes.

5. The method of claim 4 wherein the selecting step further comprises the steps of,
testing the remaining nodes on the one or more lists of nodes for each group of interest to determine reachability of each node, and
removing unreachable nodes from the list.

6. The method of claim 1 further comprising the steps of:
weeding the one or more sampling lists by removing nodes which are unreachable for a predetermined amount of time, and
adding new destinations to the sampling lists as the group of nodes of interest represented by each list increases in size.

7. The method of claim 1 further comprising the step of performing mathematical operations on the data streams to determine performance characteristics representative of a group of nodes of interest for a period of time.

8. The method of claim 1 further comprising the steps of:
establishing a threshold value for a change in a performance metric as measured over time;
analyzing the data streams using the threshold value to detect any significant changes in the value of a performance metric over time;
determining that an event has occurred when a significant change is detected.

9. The method of claim 8 wherein the presenting step further comprises the step of automatically sending an email to interested users whenever an event is detected.

10. The method of claim 1 wherein the presenting step further comprises the step of creating a ratings table showing information indicative of the performance of one or more interesting groups of nodes.

11. The method of claim 10 wherein the information indicative of performance comprises two or more performance metrics.

12. The method of claim 11 wherein the ratings table is user sortable by performance metric.

13. The method of claim 1 wherein the presenting step further comprises the step of creating a graph showing the performance of one or more interesting groups of nodes over time.

14. The method of claim 13 wherein the step of creating the graph further comprises the step of drawing a shaded region representing a detected performance event.

15. The method of claim 14 further comprising the step of placing tags on borders of the shaded region, the tags comprising information indicative of the nature of the event, and wherein the shaded region further depicts the duration of the event.

16. The method of claim 1 further comprising the step of correcting the data within a data stream by adjusting the values of a performance metric based on geographic distance over which the sent and received signals traveled.

17. The method of claim 1 further comprising the step of correcting the data within a data stream by adjusting the values of a performance metric based on a previously observed metric value for the path over which the sent and received signals traveled.

18. A method for measuring the performance of a computer network, the method comprising the steps of:
providing a survey of network nodes;
creating at least one sampling list representative of at least a portion of the nodes;
performing a process comprising the steps of,
running a sending procedure which sends signals from a beacon to a plurality of nodes on the sampling list, the signals requesting responses from the plurality of nodes,
simultaneously running a receiving procedure which receives return signals from responding nodes, such that the signal being received at any particular time could correspond with any of the signals sent to one of the plurality of nodes, and
simultaneously running a recording procedure which records data characterizing the corresponding sent and received signals;
performing data reduction on the data to create data streams comprising information indicative of the performance of at least a portion of the network; and
presenting information derived from the data streams to a user such that the user is able to draw conclusions about the performance of at least a portion of the network.

19. The method of claim 18 further comprising the steps of,
determining a size for a chunk that the beacon is capable of running through the process utilizing fast memory exclusively,
reading a chunk into fast memory before running the sending, receiving, and recording procedures;
writing the recorded data to slow memory after the sending, receiving, and recording procedures have been completed for the chunk, and
repeating the reading step, sending, receiving, and recording procedures, and writing step on sequential chunks until all of the chunks have been run through the process.

20. The method of claim 19 wherein the chunk comprises an array of records, each record representing a node to be measured, and wherein the sending procedure further comprises the steps of,
selecting a record from the chunk,
transmitting a packet to the destination represented by the record, the packet being encoded with information corresponding to the selected record,
identifying the record as having a packet in flight, and
repeating the selecting, transmitting, and identifying steps as long as less than a predetermined number of packets are in flight.

21. The method of claim 20 wherein the sending procedure further comprises the step of incrementing a flying counter any time a packet is transmitted.

22. The method of claim 21 wherein the receiving procedure further comprises the steps of,
accepting a packet,
determining whether the packet corresponds with a record identified as having a packet in flight,
decrementing the flying counter if the packet corresponds to a record identified as having a packet in flight, and
identifying any corresponding record as not having a packet in flight.

23. The method of claim 20 wherein the receiving step further comprises the steps of,
accepting a packet, and
determining whether the packet corresponds with a record identified as having a packet in flight, and
identifying any corresponding record as not having a packet in flight.

24. A method of creating a sampling list for measuring performance of a group of nodes of interest on a large computer network, the method comprising the steps of:
obtaining a population survey of the nodes on the network;
gathering data regarding topology of the network;
creating a list of nodes in the group of nodes of interest based on the gathered data;
trimming the list of nodes by excluding from the list those nodes which are not important to the performance of other nodes;
testing the remaining nodes on the list of nodes to determine reachability of each node;
removing unreachable nodes from the list;
categorizing the nodes on the list according to the service type the node provides;
excluding nodes on the list that fall within over-represented service types for the particular emphasis of the group of nodes of interest.

25. A method of correcting data collected about one or more nodes remotely located from a data collection point, the method comprising the steps of:
providing data comprising performance metrics, the data having been collected by a beacon at the collection point by sending signals to and receiving signals from one or more nodes;
determining a great circle distance over which the signals traveled between the collection point and one or more nodes;
calculating the time required for the signal to traverse the distance using the speed of light within the link and the determined distance for one or more nodes to find a geographic distance factor; and
subtracting the appropriate geographic distance factor from the metric values within the data to provide corrected data.

26. A method of correcting new data collected about one or more nodes remotely located from a beacon, the method comprising the steps of:
providing pre-collected data, the pre-collected data having been collected by the beacon by sending signals to and receiving signals from one or more nodes, and the data comprising performance metrics for a predetermined length of time;
determining a baseline metric value for the pre-collected data to find a correction factor;
subtracting the correction factor from the metric values within the new data to provide corrected data.

27. A general method for evaluating performance data of a computer network system, comprising:
receiving performance data measured from a computer network system;
selecting an appropriate event detection method to evaluate the performance data, the selected event detection method adapted to compare the performance data to threshold parameters to determine whether an event has occurred;
sending a signal indicating an event has occurred whenever an event is detected by the appropriate event detection method.

28. The method for evaluating performance data of a computer network system according to claim 27, wherein the selected event detection method comprises:
measuring the average value of performance data in a window representing a predefined number of data points;
comparing the average value of the data points within the window to determine whether it falls within a threshold range; and
recording an event if the average value of the performance data falls outside of the threshold range.

29. The method for evaluating performance data of a computer network system according to claim 27, wherein the selected event detection method comprises:
selecting a ratio threshold, an absolute minimum threshold value, and an absolute minimum difference threshold;
determining the number of consecutive data points in a sequence making up a sliding window;
selecting a first series of data points as a first sliding window;
calculating a first average value of the data points in the first sliding window;
selecting a second series of data points corresponding to the number of consecutive data points comprising a sliding window as a second sliding window, wherein the second sliding window comprises the data points in the first sliding window minus the oldest data point in the first sliding window, plus a new added data point that is the next data point in a sequence;
calculating a second average value of the data points in the second sliding window; and
recording an event if the ratio of the second average to the first average is greater than or equal to the ratio threshold, the second average exceeds an absolute minimum threshold value, and the difference between the average value of the second window and the average value of the first exceeds an absolute minimum difference threshold.

30. The method for evaluating performance data of a computer network system according to claim 27, wherein the selected event detection method comprises:
setting a range of line slope values as a threshold range for event detection;
setting an array of weights in a filter kernel to be applied to performance data points;
adding data points to a filter window until a predetermined number of data points has been added to the filter window;
applying the filter kernel to the data points in the filter window to produce filtered data points;
adding filtered data points to a line fit window until a predetermined number of filtered data points is added to the line fit window;
fitting the best least squares line to the filtered data points in the line fit window;
determining the slope of the fitted line;
comparing the slope of the fitted line to the threshold range of line slopes; and
recording an event if the slope of the fitted line falls outside of the threshold range.

31. The method for evaluating performance data of a computer network system according to claim 27, wherein the selected event detection method comprises:
setting a range of line slope values as a start slope threshold for detecting the start of an event;
setting a range of line slope values as an end slope threshold for detecting the end of an event;
setting an array of weights in a start filter kernel to be applied to performance data for detecting the start of an event;
setting an array of weights in an end filter kernel to be applied to performance data for detecting the end of an event;
setting the initial state of the system to “not_event”;
adding data points to a start filter window until a predetermined number of data points has been added to the start filter window whenever the system state is “not_event”;
producing start filtered data points by applying the start filter kernel to the start filter window whenever the system state is “not_event”;
fitting a best least squares line to the start filtered data points whenever the system state is “not_event”;
determining the slope of the line fitted to start filtered data whenever the system state is “not_event”;
comparing the slope of the fitted line to the start slope threshold whenever the system state is “not_event”;
recording the start of an event if the slope of the fitted line falls outside of the threshold range for detecting the start of an event whenever the system state is “not_event”;
changing the state of the system to “event” if the start of an event is recorded;
adding data points to an end filter window until a predetermined number of data points has been added to the end filter window whenever the system state is “event”;
producing end filtered data points by applying the end filter kernel to the end filter window whenever the system state is “event”; fitting the best least squares line to the end filtered data points whenever the system state is “event”;
determining the slope of the line fitted to end filtered data whenever the system state is “event”;
comparing the slope of the fitted line to the end slope threshold whenever the system state is “event”;
recording the end of an event if the slope of the fitted line falls within the threshold range for detecting the end of an event and if the variance of the data points within the end filter window falls within a given threshold range whenever the system state is “event”; and
changing the state of the system to “not_event” if the end of an event is recorded.

32. A method of combining data streams comprising:
providing two or more input data streams, the data streams representing data collected over a time interval, and each data stream comprising one or more records, each record including a start time indicating the time at which a collection process began collecting the data within the record and a value for one or more metrics;
defining sequential time slices, each time slice comprising a piece of the interval and being the duration of the interval divided by a frequency;
sorting the records from the two or more data streams by the start time;
allocating each record into the time slice in which the start time for each record falls;
calculating one or more statistics for each time slice, each statistic representing the value of one or more metrics for the records allocated to each time slice; and
outputting a data stream comprising records which include the calculated statistics.

33. The method of claim 32 wherein the calculated statistics comprise medians.

34. The method of claim 32 further comprising the step of:
defining an offset,
wherein the first time slice begins at the first time frequency after the interval begins plus the offset.

35. The method of claim 32 wherein the formats of the output data stream and each of the input data streams are identical.

36. A method of selectively notifying interested users of a performance event, the method comprising the steps of:
receiving a signal indicating that an event has been detected and the type and magnitude of the event;
composing an email message indicating that an event has been detected and the type and magnitude of the event;
comparing the indications to records within a file comprising conditions in which users desire to be notified of performance events;
automatically sending the email to users whose records included a condition met by the indications.

37. The method of claim 36 wherein the composing step further comprises the step of including in the email an auto-reply option which a user can quickly use to indicate that the user does not want to be notified of similar events in the future, and the method further comprising the step of updating the conditions in the responding user's record in the file.

38. A method of displaying performance characteristics of at least a portion of a network, the method comprising the steps of:
providing values for metrics indicative of the performance of at least a portion of the network; and
producing an image including cells organized in columns and one or more rows, each column representing a performance metric, each row representing at least a portion of the network, each cell including values for a metric as measured over one or more time intervals.

39. The method of claim 38 wherein the order in which portions of the network are listed is user sortable by metric.

40. A method of displaying performance characteristics of at least a portion of a network, the method comprising the steps of:
providing values for metrics indicative of the performance of at least a portion of the network;
producing an image including a time versus metric graph indicative of the performance of at least a portion of the network;
drawing a shaded region representing a detected performance event on the graph.

41. The method of claim 40 further comprising the step of placing tags on borders of the shaded region, the tags comprising information indicative of the nature of the event, and wherein the shaded region further depicts the duration of the event.

42. A method of collecting data from a large number of nodes on a computer network in a short time, the method comprising:
providing a sampling list comprising information indicative of the addresses of nodes about which data is to be collected; and
performing a process comprising the steps of,
running a sending procedure which sends signals from a beacon to a plurality of nodes on the sampling list, the signals requesting responses from the plurality of nodes,
simultaneously running a receiving procedure which receives return signals from responding nodes, such that the signal being received at any particular time could correspond with any of the signals sent to one of the plurality of nodes, and
simultaneously running a recording procedure which records data characterizing the corresponding sent and received signals.

43. The method of claim 42 further comprising the steps of,
determining a size for a chunk that the beacon is capable of running through the process utilizing fast memory exclusively,
reading a chunk into fast memory before running the sending, receiving, and recording procedures;
writing the recorded data to slow memory after the sending, receiving, and recording procedures have been completed for the chunk, and
repeating the reading step, sending, receiving, and recording procedures, and writing step on sequential chunks until all of the chunks have been run through the process.

44. The method of claim 42 wherein the sent signals are pings.

45. The method of claim 44 wherein the number of pings in flight is limited to a predefined value, pings in flight being those pings which have not timed out or for which a response has not yet been received.

46. A method of collecting topological information about a large number of nodes on a computer network in a short time, the method comprising:
providing a sampling list comprising information indicative of the addresses of example nodes; and
performing a process comprising the steps of,
running a sending procedure which sequentially sends a predetermined number of signals from a beacon toward each of a plurality of nodes on the sampling list, the sequentially sent signals being sequentially encoded with a time to live parameter,
simultaneously running a receiving procedure which receives return signals from responding hops along the route to each destination, the hops reporting an expired time to live, such that the signal being received at any particular time could correspond with any of the signals sent toward the plurality of nodes, and
simultaneously running a recording procedure which records data characterizing the corresponding sent and received signals.

47. The method of claim 46 further comprising the steps of,
determining a size for a chunk that the beacon is capable of running through the process utilizing fast memory exclusively;
reading a chunk into fast memory before running the sending, receiving, and recording procedures;
writing the recorded data to slow memory after the sending, receiving, and recording procedures have been completed for the chunk, and
repeating the reading step, sending, receiving, and recording procedures, and writing step on sequential chunks until all of the chunks have been run through the process.
